(19) United States
(12) Patent Application Publication
(10) Pub. No.: US 2022/0237719 A1
(43) Pub. Date: Jul. 28, 2022

(54) FACILITATING DYNAMIC RESOURCE MANAGEMENT AND RECONCILIATION

(71) Applicant: POLLEN, INC., Leawood, KS (US)

(72) Inventors: Kevin Daniels, Leawood, KS (US); Olivia Beins, Roeland Park, KS (US)

(21) Appl. No.: 17/587,895

(22) Filed: Jan. 28, 2022

Related U.S. Application Data
(60) Provisional application No. 63/142,623, filed on Jan. 28, 2021.

(51) Int. Cl. G06Q 50/16; G06Q 40/02; G06Q 20/06; G06Q 20/10

(52) U.S. Cl. CPC G06Q 50/167; G06Q 20/102; G06Q 20/065; G06Q 40/025

(57) ABSTRACT

Systems, methods and computer-readable media are provided for facilitating dynamic resource management. In embodiments, a candidate modification parameter indicating a candidate modification to apply to an event is obtained. In response to obtaining the candidate modification parameter, a resource collection is determined, from among a plurality of resource collections, to support the event. The resource collection can be determined based on the candidate modification parameter and a set of resource parameters associated with the resource collection. A modification to be applied to modify the event is identified in accordance with the candidate modification parameter. Thereafter, an event modification is initiated by instructing at least one resource management software to modify event data associated with the event so as to correspond to the event modification.

### RELATED APPLICATIONS

This application claims the benefit of U.S. Provisional Application No. 63/142,623, titled “Facilitation Dynamic Resource Management and Reconciliation,” filed Jan. 28, 2021, which is hereby expressly incorporated by reference in its entirety.

### BACKGROUND

Resource transfers oftentimes occur between two entities, that is, an entity providing a resource and an entity receiving the resource. In some cases, a third-party entity may partake in a resource transfer by providing a resource to an entity on behalf of another entity. In such cases, some conventional systems may enable a manual selection or toggling by a user to designate an entity to provide resources (e.g., an original entity associated with a resource transfer or a third-party entity to provide the resources on behalf of the original entity). For example, an entity initially providing resources may select to have a third-party entity provide the resources on behalf of the entity. In such a case, the third-party provides the resources until a selection is made to revert back to the entity providing resources. Accordingly, the designation of the entity providing resources is a manual selection that remains static until a new designation is made. Such a static implementation can impede effectiveness and value of a resource transfer among entities. For example, resource transfer optimization is dependent on manual selection by an entity. Further, such manual resource selection can be tedious, thereby reducing user satisfaction.

Moreover, resource management systems are capable of maintaining data for many different types of resource transfers. Data related to resource transfers may be stored across multiple records or accounts on multiple electronic resource management systems. For example, suppose transaction event data indicates that a first entity will transfer resources to a second entity. Data related to this transaction event may be stored in a first record of an electronic resource management system. Data related to the transaction may also be stored in another record of a second electronic resource management system. Technical problems exist as electronic resource management systems are typically not integrated (e.g., based on unique application layers or distinct software platforms that are offered by different vendors).

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

At a high level, aspects described herein relate to improvements to computer-performed resource management technologies. Embodiments disclosed herein comprise technologies that improve resource management technology. In particular, various aspects described herein facilitate dynamic resource management by dynamically determining or identifying resources (e.g., resource collections) to support an event. Generally, dynamic resource management enables specific resources to be identified and designated for supporting particular events, such as resource transfers. In this regard, embodiments herein determine a particular resource collection, from among a set of resource collections, to support an event(s). Such a determination can be performed dynamically such that resource collections can be identified for various events on a case-by-case basis. In accordance with determining a particular resource collection to support an event(s), event data to modify can be determined and reconciled accordingly across multiple electronic resource management systems. In some embodiments, some aspects may be at least partially pre-determined to reduce computational load and increase certainty for the particular resource collection. In this way, the dynamic resource management may be at least partially known prior to allocation.

### BRIEF DESCRIPTION OF THE DRAWINGS

The present technology is described in detail below with reference to the attached figures, wherein:

FIG. 1 is a block diagram of an example operating environment suitable for implementing aspects of the disclosure;

FIG. 2 depicts a process flow for an example operating environment suitable for implementing aspects of the disclosure;

FIG. 3 is a diagram depicting an example computing architecture suitable for implementing aspects of the disclosure;

FIG. 4 illustrates an example set of resource collections, in accordance with embodiments described herein;

FIG. 5 illustrates another example set of resource collections, in accordance with embodiments described herein;

FIG. 6 depicts a first example process flow for facilitating dynamic resource management, in accordance with embodiments of the disclosure;

FIG. 7 depicts a second example process flow for facilitating dynamic resource management, in accordance with embodiments of the disclosure;

FIG. 8 depicts a third example process flow for facilitating dynamic resource management, in accordance with embodiments of the disclosure;

FIG. 9 depicts a fourth example process flow for facilitating dynamic resource management, in accordance with embodiments of the disclosure; and

FIG. 10 is a block diagram of an exemplary computing environment suitable for use in implementing an embodiment of the disclosure.

### DETAILED DESCRIPTION

The subject matter of aspects of the disclosure is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Resource transfers oftentimes occur between two entities, that is, an entity providing a resource and an entity receiving the resource. Generally, the entities involved in the resource transfer are known or identified at the outset via an agreement. In some cases, a third-party entity may partake in a resource transfer by providing a resource to an entity on behalf of another entity. In such cases, some conventional systems may enable a manual selection or toggling by a user to select an original resource providing entity or a third-party entity to provide the resources. For example, an entity involved in initial resource transfers may provide resources. Thereafter, the entity may select to have a third-party entity provide the resources on behalf of the entity. In such a case, the third-party provides the resources until a selection is made to revert back to the entity providing resources. Accordingly, the designation of the resource providing entity (e.g., the original party of the resource transfer or a third-party entity performing the resource transfer on behalf of the original party) is a manual selection that remains static until a new designation is made. Such a static implementation can impede effectiveness and value of a resource transfer among entities. For example, resource transfer optimization is dependent on manual selection by an entity. Further, such manual resource selection can be tedious, thereby reducing user satisfaction.

In addition, technical problems exist with conventional technology to determine whether a particular resource transfer should be modified and to cause data representing the transfer to be modified across electronic resource management systems when the transfer is modified. For example, electronic resource management systems are complex software applications that have unique application layers, making them difficult to integrate. In some instances, synchronizing electronic resource managements systems so as to modify an event would require software technicians to alter and/or adapt the application layer (or other software layers) of these electronic resource management systems, which is time consuming and costly. Additionally, if the electronic resource management system is purchased from (or is operated by) a third-party, the third-party might restrict altering or adapting any aspect of the electronic resource management system, thereby preventing the synchronization of electronic resource management systems. Further complicating matters, entities involved in modifying an event might employ disparate resource management systems that require specific commands to access and/or modify event data in their respective data repositories.

Accordingly, at a high level, embodiments disclosed herein comprise technologies that improve resource management technology. In particular, various aspects described herein facilitate dynamic resource management by dynamically determining or identifying resources (e.g., resource collections) to support an event. Generally, dynamic resource management enables specific resources to be identified and designated for supporting particular events, such as resource transfers. In this regard, embodiments herein determine a particular resource collection, from among a set of resource collections, to support an event(s). Such a determination can be performed dynamically such that resource collections can be identified for various events on a case-by-case basis. To determine a particular resource collection to support an event(s), event modifications parameters and/or resource parameters may be analyzed to identify a resource collection to support an event.

In accordance with determining a particular resource collection to support an event(s), event data to modify can be determined and reconciled accordingly across multiple electronic resource management systems. In operation, an appropriate event data modification can be determined and used to reconcile event data, for instance, maintained by electronic resource management systems. Enabling event modification can provide flexibility in how much and/or when resources are transferred so as to meet demands of particular system or entity.

For example and as further described herein, a first and second electronic resource management system may store data about an event. The event may be related to transfer of resources between one or more entities. Event data for the event may include data for the amount of resources (or indication of resources) that will be transferred, a scheduled time for transferring the resources, the entities involved in the resource transfer, or other information about event. More particularly, the first electronic resource management system may store data about inbound resources to be received and the second electronic resource management system may store data about outbound resources to be transferred. Aspects of the instant technology can determine a resource collection for supporting the event and a manner in which to modify event data associated with the event. Based on an identified manner in which to modify event data, event data across the first and second electronic resource management system can be reconciled, thereby improving how a computer manages the transfer of resources and maximizes the availability of resources at any given time. As described herein, in some embodiments, a third electronic resource management system associated with a third-party may be involved with the resource transfer. For example, the third-party may provide the resource collection identified for supporting the event. In such a case, event data can also be managed or reconciled within the third electronic resource management system to effectively manage the resource transfer.

For the sake of clarity and consistency, many of the examples describe the instant technology within the context of financial transactions, which often have imposed technical constraints related to timing and validation, as well as time-dependent variables. However, the underlying improvements to technologies or the computer are not limited to the financial industry. One skilled in the art would recognize that the improvement of dynamically determining a resource for supporting an event and reconciling event data can be utilized in many different industries and/or technology areas that manage the transfer of resources.

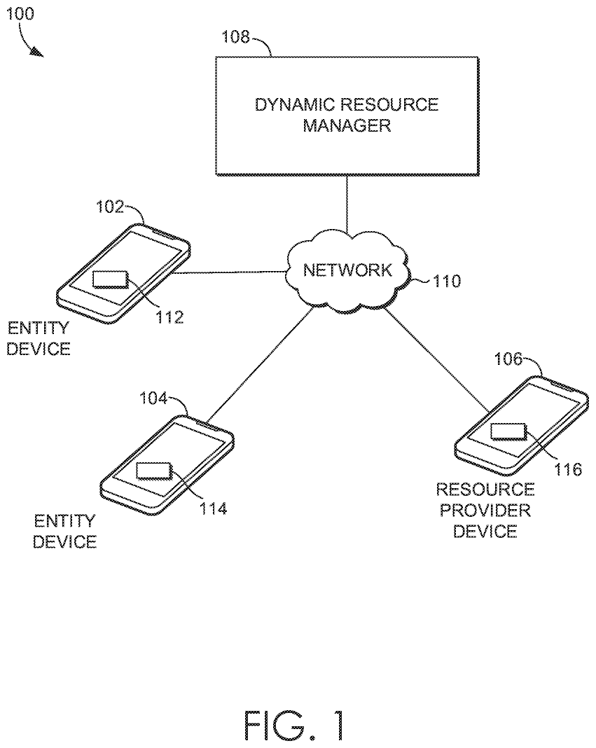

Turning now to FIG. 1, a block diagram is provided showing an example operating environment 100 in which some embodiments of the present disclosure may be employed. It should be understood that this and other arrangements described herein are set forth only as examples. Other arrangements and elements (e.g., machines, interfaces, functions, orders, and groupings of functions) can be used in addition to or instead of those shown, and some elements may be omitted altogether for the sake of clarity. Further, many of the elements described herein are functional and may be implemented as discrete or distributed components or in conjunction with other components, and in any suitable combination and location. Various functions described herein as being performed may be carried out by hardware, firmware, and/or software. For instance, some functions may be carried out by a processor executing instructions stored in memory.

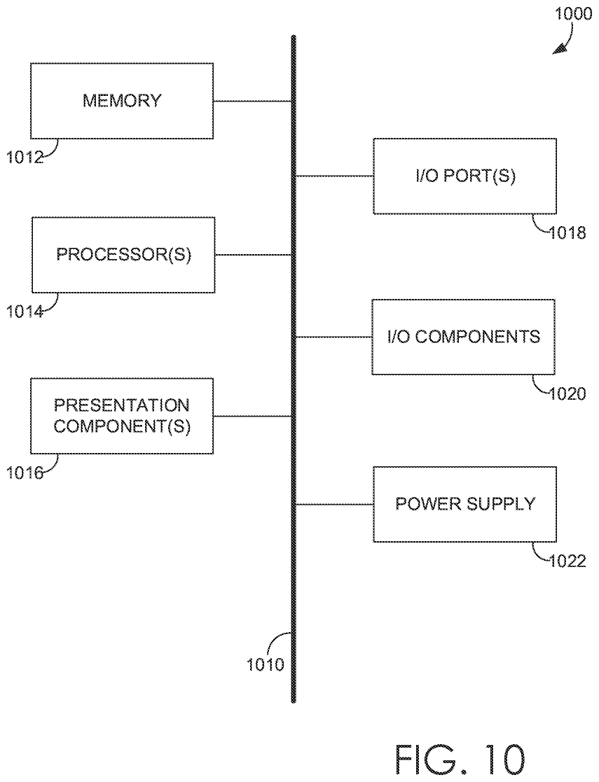

Among other components not shown, example operating environment 100 includes a number of computing devices, such as entity device 102, entity device 104, resource provider device 106, and dynamic resource manager 108. It should be understood that operating environment 100 shown in FIG. 1 is an example of one suitable operating environment. Each of the components shown in FIG. 1 may be implemented via any type of computing device, such as computing device 1000 described in connection to FIG. 10, for example.

These components may communicate with each other via network 110, which may be wired, wireless, or both. Network 110 can include multiple networks, or a network of networks, but is shown in simple form so as not to obscure aspects of the present disclosure. By way of example, network 110 can include one or more wide area networks (WANs), one or more local area networks (LANs), one or more public networks such as the Internet, and/or one or more private networks. Where network 110 includes a wireless telecommunications network, components such as a base station, a communications tower, or even access points (as well as other components) may provide wireless connectivity. Networking environments are commonplace in offices, enterprise-wide computer networks, intranets, and the Internet. Accordingly, network 110 is not described in significant detail.

It should be understood that any number of entity devices, resource provider devices, and dynamic resource managers may be employed within operating environment 100 and within the scope of the present disclosure. Each may comprise a single device or multiple devices cooperating in a distributed environment. For instance, dynamic resource manager 108 may be provided via multiple devices arranged in a distributed environment that collectively provide the functionality described herein. Additionally, other components not shown may also be included within the distributed environment.

Entity devices 102 and 104 and resource provider device 106 can be client devices on the client-side of operating environment 100, while the dynamic resource manager 108 can be on the server-side of operating environment 100. Dynamic resource manager 108 can comprise server-side software designed to work in conjunction with client-side software on client devices, such as devices 102, 104, and 106 so as to implement any combination of the features and functionalities discussed in the present disclosure. This division of operating environment 100 is provided to illustrate one example of a suitable environment, and there is no requirement for each implementation that any combination of entity device 102, entity device 104, resource provider device 106, and dynamic resource manager 108 remain as separate entities.

Entity device 102, entity device 104, and resource provider device 106 may comprise any type of computing device capable of use by a user (e.g., individual associated with an entity or resource provider). For example, in one embodiment, entity device 102, entity device 104, and resource provider device 106 may be the type of computing device described in relation to FIG. 10 herein. By way of example and not limitation, an entity device and/or resource provider device may be embodied as a personal computer (PC), a laptop computer, a mobile or mobile device, a smartphone, a tablet computer, a smart speaker, a smart watch, a wearable computer, a personal digital assistant (PDA), a music player or an MP3 player, a global positioning system (GPS) or device, a video player, a handheld communications device, a gaming device or system, an entertainment system, a vehicle computer system, an embedded system controller, a camera, a remote control, a bar code scanner, a computerized measuring device, an appliance, a consumer electronic device, a workstation, or any combination of these delineated devices, or any other suitable computer device.

The entity devices 102 and 104 and resource provider device 106 can include one or more processors, and one or more computer-readable media. The computer-readable media may include computer-readable instructions executable by the one or more processors. The instructions may be embodied by one or more applications, such as application 112, 114, and 116 shown in FIG. 1. Applications 112, 114, and 116 are referred to as single applications for simplicity, but its functionality can be embodied by one or more applications in practice. Other entity and resource provider devices (not depicted in FIG. 1) can include one or more applications similar to applications 112, 114, and/or 116.

Entity devices 102 and 104 generally represent devices used by an entity, or individual thereof, corresponding with an event or set of events. In this regard, an entity generally refers to a party (e.g., organization, individual, etc.) involved or associated with an event. As described, an event generally refers to an occurrence or instance of a resource transaction (e.g., a financial transaction). Accordingly, an entity may be a buyer or a seller of goods and/or services resulting in a financial transaction between the buyer and seller. For example, a first entity device 102 may represent a device used by a buyer entity (monetary provider), and a second entity device 104 may represent a device used by a seller entity (monetary recipient).

Applications 112 and 114 operating on entity devices 102 and 104, respectively, may be any application with which an entity, or user associated therewith, interacts. Generally, applications 112 and 114 are capable of facilitating exchange of information between the entity devices, respectively, and the dynamic resource manager 108 in carrying out dynamic resource management. In some implementations, the application(s) comprise a web application, which can run in a web browser, and could be hosted at least partially on the server-side of environment 100 (e.g., dynamic resource manager 108). In addition, or instead, the application(s) can comprise a dedicated application, such as an application having electronic resource management functionality (e.g., dynamic resource management). In some cases, the application(s) is integrated into the operating system (e.g., as a service). It is therefore contemplated herein that “application” be interpreted broadly.

Applications 112 and 114 may be the same application or different applications developed to service different entities. For example, in some cases, application 112 and 114 may have functionality that can be used by both entities associated with an event (e.g., a buyer and a seller). In other cases, application 112 and 114 may be different applications, with one application having functionality for use by a first entity associated with an event (e.g., a buyer) and another application having functionality for use by a second entity associated with an event (e.g., seller).

As described, applications 112 and 114 may include functionality for use by a buyer entity and/or a seller entity associated with an event(s). Buyer entity functionality generally refers to functionality that facilitates performing dynamic resource management in association with a buyer. A buyer, as described herein, includes an entity that purchases a product or service and, in return, has an obligation to make a payment as part of a financial transaction event. Seller entity functionality generally refers to functionality that facilitates performing dynamic resource management in association with a seller. A seller, as described herein, includes an entity that sells a product or service in exchange for a payment. As such, a seller is a recipient of a payment (from a buyer) as part of a financial transaction event.

Although each of applications 112 and 114 may include functionality for operation by both a buyer entity and a seller entity associated with an event, for purposes of discussion, assume that application 112 supports buyer entity functionality on a buyer entity device 102 and application 114 supports seller entity functionality on a seller entity device 104. In such a case, turning initially to application 112, application 112 can facilitate performing dynamic resource management in association with a buying entity. In this regard, application 112 can communicate with the dynamic resource manager 108 to provide event data and/or resource parameters.

An event may generally be associated with a resource transfer operation. The resource transfer may be between one or more entities. The resource being transferred may comprise a financial resource (e.g., a payment), a telecommunication or data resource (e.g., a data packet), electronic data to be processed (e.g., raw or unstructured data that is to be processed so as to generate structured data), a physical resource (a physical good or service), a digital resource (e.g., a token), or an indication of these. In some aspects, the event may occur at a particular time or time interval. For example, the event may be associated with a resource transfer that is to occur at scheduled time. When the instant technologies are employed in the financial industry, the event may be associated with a resource transfer that satisfies a financial agreement between one or more entities. For instance, the event may be associated with transferring a financial resource at a future date or historic date.

Event data may be data that provides information about the event. Generally, event data refers to data associated with an event (e.g., financial transaction). Event data may include information about the amount of resources being transferred (e.g., monetary value owed to a seller), the entities associated with the resource transfer (e.g., a buyer identifier, a seller identifier), a time for transferring the resources, items purchased, quantities purchased, and the like. In some aspects, event data may include a resource indicator that represents the amount of resources to be transferred, whether the resource to be transferred is an inbound and/or an outbound resource, a scheduled time for the resource transfer, an event identification (event ID), whether the resource transfer has been rerouted, or the like. The event identification (event ID) may be any alphanumeric code that identifies the particular event. It should be appreciated that the term entity may refer a person, institution, and/or legal entity (e.g., a corporation) associated with the transfer of resources.

The event data may include the source of the resource transfer and/or the destination of the resource transfer. The source of the resource transfer may be an entity that will initiate transfer of the resource, such as a buyer of goods and/or services. The destination of the resource transfer may be an entity receiving the resource, such as a seller of goods and/or services. The source and/or the destination of the resource transfer may be identified via a source ID and/or destination ID. The source ID and/or destination ID may be any alphabetical and/or numeric identifier that identifies the entity transferring (or receiving) the resource. The identifier may include a name, an address (physical or digital), an account number, or the like.

When the instant technology is employed in the financial industry, the event may be associated with an agreement of a first entity to pay the second entity. For instance, the event may be associated with a payment that is made or will be made by a buyer to a supplier. The scheduled time for transferring the resources may be a date that the first entity agrees to pay the second entity. A resource transfer may be described as being transferred between two entities. As describe herein, transferring a financial resource between the two entities may include transferring the financial resource between financial institutions (e.g., third-party resource provider) associated with one or both of the two entities.

A resource indicator or amount may be a digital representation of the amount of resources that will be transferred. The event identification (event ID) may be any identification of the event. In some aspects, the event ID may be invoice number, transaction number, or purchase order number associated with goods or service purchased by an entity. The source ID and/or destination ID may be a person or company name, contact information, or buyer or supplier name/address. As previously stated, the improvements to technologies or the computer provided by this disclosure are not limited to the financial industry.

A set of event data may be collected or recorded in an event record (e.g., an invoice). Stated differently, an event record may be used to capture data associated with an event. That is, an event record may represent an event (e.g., a financial transaction). Application 112 may facilitate receiving an event record (e.g., an invoice) and/or providing the event record to the dynamic resource manager 108. For example, an invoice may be input via application 112 and communicated to dynamic resource manager 108. In other cases, application 112 may trigger or initiate communication of an event record stored or obtained at another device to the dynamic resource manager 108 or enable the dynamic resource manager 108 to access an event record(s) (e.g., stored at the entity device 102 or another device, such as a data source associated with a payment system).

Resource parameters provide attributes or parameters associated with a resource collection. A resource collection refers to a set or collection of resources that can be used to satisfy or support an event (e.g., financial obligation). Resource parameters may include, for example, an amount, a payment rate, buyer entity attributes, seller entity attributes, or the like. Such resource parameters define or designate when the corresponding resources can be used to fund or source a financial payment. As such, when a buying entity provides resources for payment, the buying entity may provide resource parameters to define use of the resource via application 112.

Although event data and/or resource parameters are generally described herein as provided by a buying entity (e.g., via a buying entity device), as can be appreciated, event data and/or resource parameters can be provided in any number of ways. For example, as described below, resource parameters may be provided via a third-party resource provider. As another example, event data may additionally or alternatively be provided by a selling entity (e.g., along with a modification request).

Application 112 can facilitate input of such event data and/or resource parameters and/or provide such information to the dynamic resource manager 108 for analysis. For example, via application 112, a user may select or input an invoice and/or resource parameters. Application 112 may trigger such data to be communicated to the dynamic resource manager (e.g., via the entity device 102, a data source (not shown), or the like).

In accordance with the dynamic resource manager 108 analyzing such event data and/or resource parameters, among other things (e.g., candidate modification parameters), the entity device 102 may be provided with the event modifications applicable to the entity via application 112. In this way, application 112 can also facilitate receiving event modifications identified by the dynamic resource manager 108.

Continuing with this example implementation in which application 114 supports seller entity functionality on a seller entity device 104, application 114 can facilitate performing dynamic resource management in association with a selling entity. In this regard, application 114 can communicate with the dynamic resource manager 108 to provide candidate modification parameters. In such a case, application 114 can facilitate inputting candidate modification parameters.

Candidate modification parameters generally refer to attributes or parameters that indicate a candidate or proposed modification associated with an event (e.g., a financial transaction), or event data associated therewith. By way of example only, assume an event corresponds to a financial transaction for a particular monetary amount by a particular date. A set of candidate modification parameters may indicate modifications of the amount to be paid (e.g., a resource amount modification rate) and/or the date by which to pay, among other things. In embodiments, an entity may provide a set of candidate parameters indicating a proposed payment of the obligated debt at a particular date and/or time by proposing a discount in exchange for an early payment. As described herein, candidate modification parameters can be communicated (e.g., from a selling entity device) in association with a modification request. Such a modification request indicates a request or offer to modify an aspect of an event or set of events. The modification request may include, or otherwise be associated with, a set of candidate modification parameters indicating a modification to apply to an event(s), or event data associated therewith.

In some cases, candidate modification parameters (e.g., via an offer) may specifically correspond to an event. For example, an entity may specify a set of candidate modification parameters for a particular event record (e.g., invoice) or financial transaction associated with a buying entity. In other cases, candidate modification parameters may generally correspond with an event. For example, an entity may indicate a set of modification parameters for a particular set of events (e.g., financial transactions), events associated with a particular buyer, events associated with a set of buyers (e.g., all buyers, a specified set of buyers, or the like), events associated with a particular criteria (e.g., financial transactions over a certain amount, financial transactions to be paid within a certain number of days, etc.). Various candidate modification parameters may be required parameters that must be met for authorization or acceptance, desired parameters that are desired to be met for authorization or acceptance, recommended parameters that are suggested for authorization or acceptance, etc.

Although candidate modification parameters are generally described herein as provided by a selling entity (e.g., via a selling entity device), as can be appreciated, candidate modification parameters can be provided in any number of ways. For example, in some cases, candidate modification parameters may be selected or designated by a buying entity and confirmed or verified by a selling entity. For instance, a buyer may offer to pay an invoice early in exchange for a reduced payment. As another example, candidate modification parameters may be provided as a recommendation (e.g., via a dynamic resource manager 108) and confirmed or verified by the seller. In this regard, algorithms, machine learning, etc. may be used to determine a recommendation of candidate modification parameters. The recommended modification parameters can be provided to the selling entity as a suggestion, and the selling entity may select to confirm or approve the candidate modification parameters.

Application 114 can facilitate input of such candidate modification parameters and/or provide such information to the dynamic resource manager 108 for analysis. For example, via application 114, a user may select or input a candidate modification parameters. Application 114 may trigger such data to be communicated to the dynamic resource manager (e.g., via the entity device 104, a data source (not shown), or the like).

In accordance with the dynamic resource manager 108 analyzing such candidate modification parameters, among other things (e.g., event data and/or resource parameters), the entity device 104 may be provided with the event modifications applicable to the buying entity via application 114. In this way, application 114 can also facilitate receiving event modifications identified by the dynamic resource manager 108.

The resource provider device 106 generally represents a device used by a resource provider, or individual associated therewith. A resource provider is generally referred to herein as a provider of resources (e.g., financial contribution). A resource provider may be a buyer associated with an event or a third-party to the event (e.g., resource transfer). As such, although illustrated separately, an entity device representing a buyer (e.g., entity device 102) may also include the functionality described herein in relation to the resource provider device. As described, a resource provider may also be a third-party to an event. In this regard, a third-party resource provider is willing to support an event (e.g., fund a financial transaction between a buying and selling entity) even though not initially a party of the event. For example, a third-party resource provider may wish to provide resources in an effort to obtain financial gain. For instance, assume a buyer owes one million dollars to a seller in 30 days. In accordance with embodiments described herein, a third-party resource provider may be able to pay a discounted amount of $950,000 at an earlier date to the seller on behalf of the buyer. At the 30 day pay period, the buyer can then pay the one million dollars to the third-party resource provider (instead of the seller). As such, third-party resource provider gained $50,000 by providing resources for the transaction.

Application 116 operating on resource provider device 106 may be any application with which resource provider, or user associated therewith, interacts. Generally, application 116 is capable of facilitating exchange of information between the resource provider device and the dynamic resource manager 108 in carrying out dynamic resource management. In some implementations, the application(s) comprise a web application, which can run in a web browser, and could be hosted at least partially on the server-side of environment 100 (e.g., dynamic resource manager 108). In addition, or instead, the application(s) can comprise a dedicated application, such as an application having electronic resource management functionality (e.g., dynamic resource management). In some cases, the application(s) is integrated into the operating system (e.g., as a service). It is therefore contemplated herein that “application” be interpreted broadly.

Application 116 may be the same application or a different application as applications 112 and/or 114. For example, in some cases, application 116 may have functionality that can be used by resource providers and/or entities associated with an event (e.g., a buyer and/or a seller). In other cases, application 116 may be a different application, with application 116 only having functionality used by a resource provider. Further, application 116 may be different for a buying entity and a third-party resource providing.

Application 116 can facilitate performing dynamic resource management in association with a resource provider. In this regard, application 116 can communicate with the dynamic resource manager 108 to provide resource parameters. In such a case, application 116 can facilitate inputting resource parameters.

As described above, resource parameters refer to attributes or parameters associated with a resource collection. A resource collection refers to a set or collection of resources that can be used to satisfy or support an event (e.g., financial obligation). Resource parameters may include, for example, an amount, a payment rate, selling entity attributes, buying entity attributes, or the like. Such resource parameters define or designate when the corresponding resources can be used to fund or source a financial payment.

Different resource parameters may be provided for different resource collections. By way of example only, different resource parameter sets may be provided for various events and/or entities. For example, resource parameters may be provided specific to payment dates (e.g., one month v. three months), different entities (e.g. entity A v. entity B), different rates with different restrictions (e.g., first rate for one type of restriction, second rate for another type of restriction), different rates for different amounts, etc. As such, a particular third-party resource provider may provide multiple resource parameter sets corresponding with different resource collections.

Although only one resource provider device is illustrated in FIG. 1, any number of resource providers and/or corresponding devices may be implemented. For instance, a first resource provider may represent a buying entity, a second resource provider may represent a first bank, and a third resource provider may represent a second bank. Although a third-party resource provider is generally a bank or other financial institution, it can be appreciated that other buyer/seller entities may want to provide third-party financing for events of which the entity is not a party. For example, one buyer may want to provide financing in connection with events between a supplier and another buyer.

Application 116 can facilitate input of such resource parameters and/or provide such information to the dynamic resource manager 108 for analysis. For example, via application 116, a user may select or input resource parameters in association with a resource collection. Application 116 may trigger such data to be communicated to the dynamic resource manager (e.g., via the resource provider 106, a data source (not shown), or the like).

In accordance with the dynamic resource manager 108 analyzing such resource parameters, among other things (e.g., event data and/or candidate modification parameters), the resource provider 106 may be provided with the event modifications applicable to the resource provider via the application 116. In this way, application 116 can also facilitate receiving event modifications identified by the dynamic resource manager 108.

The dynamic resource manager 108 is generally configured to facilitate dynamic resource management. In this regard, the dynamic resource manager can dynamically determine which resource collection, from among a set of resource collections, to use to support an event(s). By way of example only, assume that a first resource collection is offered by a buyer for fulfilling or settling a financial obligation to a seller, a second resource collection is offered by a first bank for fulfilling or settling a financial obligation to the seller, and a third resource collection is offered by a second bank for settling a financial obligation to the seller. The dynamic resource manager 108 can determine which resource collection, from among the three resource collections, to use for paying the financial obligation to the seller (e.g., a modified financial obligation). As described herein, such a determination can be determined based on candidate modification parameters offered to modify an event (e.g., financial transaction) and/or resource parameters corresponding with the various available resource collections.

The dynamic resource manager 108 may comprise any type of software application platform capable of managing and/or facilitating identification of a resource collection(s) to use in association with an event(s). In accordance with determining a resource collection(s) to use in association with an event(s), the dynamic resource manager 108 can facilitate event modification. In this way, dynamic resource manager 108 may reconcile event data across systems in accordance with appropriate modification parameters.

By way of example, when the instant technology is employed in the financial industry, dynamic resource manager 108 is capable of determining which resource collection, from a set of resource collections, to use to fund a particular event, or set of events. Modification parameters associated with such events can be used to reconcile event data across systems, such as account receivables systems and account payable systems.

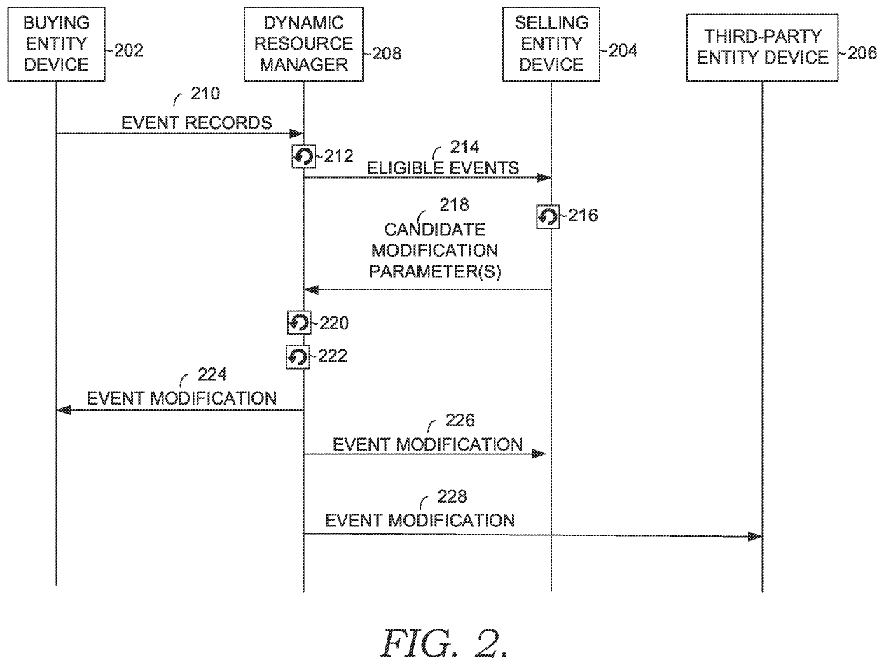

Although not illustrated, entity device 102, entity device 104, resource provider device 106, and/or dynamic resource manager 108 may communicate with any number of data sources that host data related to events. In this regard, data sources may comprise data sources and/or data systems, which are configured to make data available to any of the various constituents of operating environment 100, or system 200 described in connection to FIG. 2. For instance, in one embodiment, one or more data sources provide (or make available for accessing) event data (e.g., invoices) to dynamic resource manager 108. Such data sources may provide to (or be retrieved from) a dynamic resource manager 108 in response to a request, for example, provided by an entity device or the resource provider device. In some embodiments, data sources include computing devices or enterprise resource platform (ERP) that hosts or stores event data, or other data sources. Data sources may be discrete from entity devices, resource provider devices and dynamic resource manager. In one embodiment, one or more of data sources may be integrated into or associated with one or more of the entity devices 102 and 104, resource provider device 106, and/or dynamic resource manager 108.

By way of example only, event data may be stored in a first electronic resource management system (data source) associated with a first entity. The event data in the first electronic resource management system may indicate that a resource (e.g., an inbound resource) will be received. Corresponding event data may be stored in a second electronic resource management system (data source) associated with the second entity. The event data stored in a second electronic resource management system may indicate that the same event includes transferring a resource (e.g., an outbound resource). Event data may also include a resource indicator that represents the amount of resources to be transferred. For instance, the resource indicator may provide an indication of a packet size (e.g., 1000 bytes), a file size (e.g., 10 megabytes), an amount of financial resources to be transferred (e.g., $1000), an amount of data to be processed (e.g., 100 gigabytes), or the like.

Data sources may also include a distributed ledger network. The distributed ledger network may include a plurality of nodes that are each in communication over network 110. Each node of a distributed ledger network may also be a computing device 1000 later described in accordance with FIG. 10. In some embodiments, such as in some public blockchain implementations, each node in the distributed ledger network can operate as a peer to every other node of the distributed ledger network such that no single node is more influential or powerful than any other node. Operations performed by nodes can include, among other things, validating transactions, verifying blocks of transactions, and adding records to an immutable database that is collectively maintained by the nodes. It is contemplated, however, that in some embodiments, a particular subset of the nodes can be specifically designated for performing a subset of or all node operations described herein. In this regard, as opposed to embodiments where each node is a peer with other nodes, some embodiments can employ specially-“designated nodes” (e.g., for private blockchains or ecosystems where centralization is not a concern) that perform a subset of or all of the described node operations.

In accordance with embodiments described herein, the immutable database collectively maintained by the nodes is referenced herein as a blockchain. The blockchain maintained by the distributed ledger network includes a plurality of records that is immutable by virtue of the distributed nature of the distributed ledger network, applied cryptography concepts, and a consensus module that is independently included and operated by any number of nodes. While any node can generate a transaction to be added to the blockchain, a consensus module may require that the record be added to the blockchain based on a determination that a consensus (e.g., greater than 50%) of the nodes (or designated nodes) has collectively validated the transaction. In this regard, while each node can independently store a copy of the blockchain, a record can only be added to the blockchain when a consensus to add the record has been reached by the nodes (or designated nodes) of the distributed ledger network. The node generating the block must also include, into the block it is generating, a cryptographic hash of the block most-recently added to the blockchain. Once generated, the node generating the block can send the generated block to the nodes (or designated nodes) to which it is connected.

The nodes (or designated nodes) receiving the generated block can then verify that the block includes one or more valid transactions, includes a hash value of the block most-recently added to the blockchain, and was generated in accordance with defined consensus rules. Upon verifying the foregoing, the nodes (or designated nodes) can pass on (e.g., communicate) the verified block to its neighboring nodes (or neighboring designated nodes). In this way, similar to how a transaction is validated by a determined consensus of the distributed ledger network, the generated block including at least the transaction can be verified by another determined consensus of the nodes (or designated nodes). When a determination is made by a consensus of the nodes (or designated nodes) that a block is verified, the newly-verified block is added to the blockchain immediately subsequent to the previously-added block, the hash of the previously-added block being included in the newly-verified block. As such, each block is cryptographically “chained” to a previous block and a subsequent block. In other words, the cryptographic hashes facilitate maintenance of the order and accuracy of records included in the blockchain.

In various embodiments, the blockchain is not necessarily limited to storing records relating to transfers of digital tokens or monetary value. In this regard, a record can include any type of electronic record, including but not limited to one or more transactions, smart contracts, electronic documents, images or other digital media, URIs, alphanumeric text, unique identifiers, I.P. addresses, timestamps, hashes of any of the foregoing, or references to any of the foregoing. Any of the foregoing examples can be viewed as being the subject of a transaction, or can be indirectly associated with a transaction. For instance, ownership of an asset or record of an event stored in a medium other than the blockchain (e.g., a remote storage device, a cloud server, a database) can be referenced with a unique identifier. If the asset is a digital asset, a URI and/or hash of the digital asset can be the subject of the transaction. If the asset is a tangible asset, a unique identifier associated with the tangible asset can be the subject of the transaction. It is contemplated that any combination or alternative to the foregoing examples remain within the purview of the present disclosure.

In some embodiments, information about an event (e.g., event data) may be stored in a record maintained by one or more nodes of the distributed ledger. Additionally or alternatively, information associated with modifying the event may be stored in a record maintained by one or more nodes of the distributed ledger. It is contemplated that the components of system 100 may access the distributed ledger to obtain information associated with an event. It is also contemplated that the components of system 100 may provide information associated with an event (e.g., new event data and/or rerouted event data) to the one or more nodes of the distributed ledger. The one or more nodes may then include information associated with the event in a newly generated block that is confirmed by other nodes and then added to the distributed ledger, as described herein.

Turning now to FIG. 2, FIG. 2 illustrates an exemplary workflow between various devices and components. In particular, FIG. 2 provides an example implementation 200 including a buying entity device 202, a selling entity device 204, a third-party entity device 206, and a dynamic resource manager 208. The buying entity device 202, the selling entity device 204, the third-party entity device 206, and the dynamic resource manager 208 may implement functionality similar to that as described with respect to the corresponding components in FIG. 1.

Initially, event records 210 are communicated from the buying entity device 202 to the dynamic resource manager 208. Generally, event records 210 represent events (e.g., financial transactions) and may include various event data. At block 212, the dynamic resource manager 208 determines whether the events are eligible for modification. For events identified as eligible for modification, the dynamic resource manager 208 communicates eligible events 214 (e.g., via event records) to the selling entity device 204. In response, the selling entity device 204 receives 216 one or more candidate modification parameters for the eligible events. For example, a selling entity may input or select candidate modification parameter(s) specific to the eligible events. The candidate modification parameter(s) 218 is communicated to the dynamic resource manager 208. At block 220, a resource collection for use in satisfying or supporting the events is determined. As described in various implementations, the resource collection can be identified based on various resource parameters associated with different resource collections (e.g., provided by the resource provider) and/or the candidate modification parameter(s) provided by the selling entity device 204. At block 222, event modifications are determined. Event modifications can be determined, for example, based on the candidate modification parameters (e.g., a resource amount and a resource transfer date) and/or resource parameters (e.g., the resource provider). For example, assume a candidate modification parameter indicates a reduction in payment amount of 3%. In such a case, an event modification of a 3% reduction or a corresponding amount may be identified.

The dynamic resource manager 208 can then provide event modifications for initiating event data modification in appropriate systems (e.g., electronic resource management systems). As shown, in FIG. 2, the dynamic resource manager 208 provides appropriate event modifications 224, 226, and 228 to buying entity device 202, seller entity device 204, and third-party resource provider 208. By way of example only, event modification 224 may indicate a reduced payment amount being paid to the resource provider on the original resource transfer date/date range. Event modification 226 may indicate a reduced payment amount being paid by the resource provider on an earlier resource transfer date. Event modification 228 may indicate a reduced payment being paid by the resource provider on an earlier resource transfer date and indicate an original payment amount being paid to the resource provider on the original resource transfer date. Although FIG. 2 illustrates the event modifications being provided to the buying, selling, and third-party resource providers, as can be appreciated, such event modifications can be provided to corresponding electronic resource management systems, as described herein, to effectuate modifications of the events.

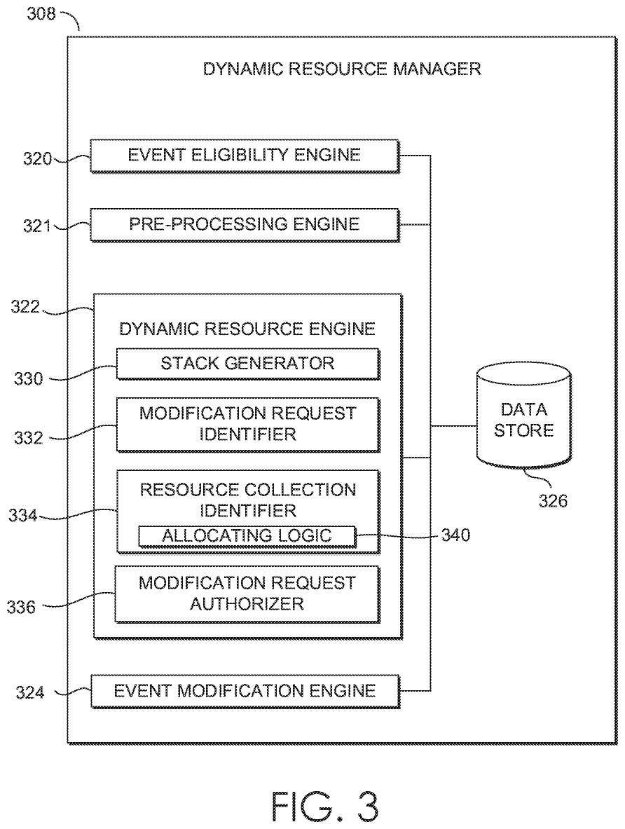

Referring to FIG. 3, aspects of an illustrative dynamic resource manager are shown, in accordance with various embodiments of the present disclosure. In embodiments of the invention, the dynamic resource manager 308 includes an event eligibility engine 320, a pre-processing engine 321, a dynamic resource engine 322, an event modification engine 324, and a data store 326. Such components may be embodied as a set of compiled computer instructions or functions, program modules, computer software services, or an arrangement of processes carried out on one or more computer systems, such as computing device 1000 described in connection to FIG. 10, for example. The foregoing components of dynamic resource manager 308 can be implemented, for example, in operating environment 100 of FIG. 1.

Data store 326 can store computer instructions (e.g., software program instructions, routines, or services), data, and/or models used in embodiments described herein. In some implementations, data store 326 stores information or data received or generated via the various components of dynamic resource system 308 and provides the various components with access to that information or data, as needed. Although depicted as a single component, data store 326 may be embodied as one or more data stores. Further, the information in data store 326 may be distributed in any suitable manner across one or more data stores for storage (which may be hosted externally). In embodiments, data stored in data store 326 includes event data, candidate modification parameters, resource parameters, event modification data, eligibility criteria, and/or the like, as generally discussed herein.

As described above, the dynamic resource manager 308 can operate in a server environment and communicate with various devices, such as entity devices associated with an event, resource provider devices, and/or data sources associated therewith. In this way, dynamic resource manager 308 can obtain information and/or provide information to such devices via a network.

The event eligibility engine 320 is configured to determine whether events are eligible, or qualify, for event modification(s). To this end, in embodiments, the event eligibility engine 320 analyzes whether an event is eligible to be modified, for example, to adjust financial obligation terms, such as a payment amount, a payment rate, a payment date, or the like. A payment rate may be a discount rate that is a flat rate to discount invoices or an annual percentage rate (APR) to determine an individual rate of discount for each invoice depending on how early a payment is made (or by days-paid-early (DPE)). If an event(s) is deemed eligible for event modification, the dynamic resource engine 322 can determine a resource collection for supporting or funding the modified event (e.g., providing payment in accordance with a modified financial transaction).

To determine event eligibility, the event eligibility engine 320 may analyze event data associated with an event to determine whether the event data meets eligibility criteria. As described, event data generally refers to any data associated with or indicating an event. Event data may include, among other things, entities associated with a resource transfer (e.g., a buying entity and a selling entity), an amount of resources to be transferred, and a scheduled time for the resource transfer to take place. Eligibility criteria generally refers to criteria or thresholds that define when events are eligible for event modification. Eligibility criteria may correspond to any type of event data. By way of example only, eligibility criteria may define an amount threshold (e.g., a minimum or maximum resource amount), a date or date range threshold (e.g., a resource transfer occurring before or after a date, or within a range of dates), a particular entity corresponding with an event (e.g., a particular buying entity), and/or the like.

Accordingly, the event eligibility engine 320 may analyze event data associated with an event to determine whether the event data meets eligibility criteria. In some cases, a particular eligibility criteria may be required to be satisfied for the event to be eligible for modification. In other cases, each established eligibility criteria may be required for the event to be eligible for modification.

In implementation, the event eligibility engine 320 can obtain event data, for example, via event records (e.g., invoices). Such event data may be received from an entity, or a data source associated therewith. For instance, a buying entity may provide or designate an invoice or set of invoices for which an event modification may be desired or accepted by the buying entity. The event eligibility engine 320 can then access a set of one or more eligibility criteria and determine whether the event data meets the eligibility criteria, or portion thereof. For example, an amount of a particular financial transaction can be compared to an amount threshold and, if the financial transaction amount exceeds the amount threshold, the particular financial transaction (e.g., via an invoice) can be identified as eligible for event modification.

Eligibility criteria can be provided in any number of ways. As one example, a buying or selling entity may provide a set of eligibility criteria, for example, via a graphical user interface. As another example, an organization providing the dynamic resource manager 308 may establish eligibility criteria. For example, a company managing, developing, and/or controlling the dynamic resource manager 308 may specify eligibility criteria. In some cases, eligibility criteria may be specific to an event entity, such as a buying entity, or a set of events. In other cases, eligibility criteria may be applicable to any events.

Determining event eligibility may occur at various times, and is not intended to be limited herein. For example, in some embodiments, a buying entity may be presented, via a graphical user interface, with a list of invoices for which the buying entity is to pay various monetary amounts to a selling entity(s). Assume the buying entity selects any or all of the invoices as desired to enable term modification associated with the invoices (e.g., payment amount and/or payment date). In such a case, the event eligibility engine 320 can obtain such invoices, or data associated therewith, and determine whether the invoices are eligible for event modification. As another example, event eligibility engine 320 may analyze all available invoices associated with a buying entity and determine event eligibility for each invoice. The eligible invoices can then be presented to the buying entity, such that the buying entity can select from the eligible invoices to enable event modification.

In some embodiments, an indication or record indicating that an event(s) is eligible for modification may be stored in data store 326 (e.g., in association with the applicable entity(s)). As can be appreciated, in some cases, an event eligibility engine 320 is not needed. For example, any event may be considered eligible for modification.

In some implementations, a selling entity may be notified that events are eligible for modification. For example, a notification or message may be communicated by the event eligibility engine 320 to a selling entity that indicates events associated with the selling entity are eligible for modification. For the sake of clarity, even though an event is eligible for modification, as determined by event eligibility engine 320, the event may not ultimately be modified (e.g., as determined by the dynamic resource engine 322). The pre-processing engine 321 may perform a preliminary calculation, determination, routing, or triaging of the modification request. In some embodiments, the event and/or the modification request may be a trigger for the pre-processing engine 321. In some instances, the event may trigger the pre-processing engine 321. In other embodiments, a modification request related to that event may trigger the pre-processing engine 321. The preprocessing engine 321 may narrow a field of possible modifications based upon one or more criteria. In some embodiments, the pre-processing engine 321 may be activated upon the event eligibility engine 320 determining that an event is eligible for modification. The pre-processing engine 321 may thus determine a decreased a set of possible modifications to reduce the overall computations to be performed by the dynamic resource engine 322 (discussed herein). The pre-processing engine 321 may thus improve the efficiency of the dynamic resource engine 322 by streamlining the calculations to be performed. The pre-processing engine 321 may triage the received event and/or modification request to determine a priority, a category, a buyer, or other characteristic about the event and/or modification request before committing the resources of the dynamic resource engine 322. In some instances, simple requests may be handled fully by the pre-processing engine 321, such as in the case of known modifications having a single resolution based upon a certain rule.

The pre-processing engine 321 may identify one or more characteristics of the event based upon one or more rules utilized by the pre-processing engine 321. As used herein, a rule may be a threshold, a correlation, an association, a condition, or other logic that is indicative of how the received event or modification request should be processed or otherwise treated. As an example, a rule may exist in which all events related to a certain geographic area may be directed to a certain set of resource allocations (such as buying entities). Thus when an invoice is received for that geographic area, the pre-processing engine 321 may instruct the dynamic resource engine 322 to only consider buying entities within the certain set of buying entities associated with that geographic region. As such, the calculations performed by the dynamic resource engine 322 may be reduced. In some embodiments, the rules may be input by a human operator or may be determined programmatically based upon other criteria. For example, the pre-processing engine 321 may develop a rule that treats certain events in a certain way based upon one or more past iterations of similar treatments of similar events. In some implementations the rules, or logic that comprises the rules, may reflect a pattern of historic treatments of certain types of events. The pattern may be determined by pre-processing engine 321 based on the criteria and outcome of the events. In this way, the pre-processing engine 321 may programmatically develop new rules, as well as adapt existing rules to criteria that may change or evolve. Similarly, by determining patterns of historic event outcomes such as routing, pre-processing engine 321 effectively learns how to handle future, new events. Additionally, in this way, the pre-processing engine 321 may reduce its own computational load by determining (and/or modifying) and applying the one or more rules.

In some instances, an offer may be received and then routed via the pre-processing engine 321 to perform preliminary calculations or at least partially decide a resource allocation or subset of possible resource allocations for that offer. The offer may be routed based upon one or more characteristics of the offer, the event, or other information. The characteristics are compared to the rules to see which, if any, rules may apply to this offer. Based upon one or more rules applying, an appropriate destination for the offer (or a subset of possible destinations) may be determined and the offer routed to that destination (or subset of possible destinations).

In other embodiments, an offer is received and the analysis of the dynamic resource engine 322 may be performed thereafter (as discussed herein) without any pre-processing. In still other embodiments, the steps described herein as being performed by the pre-processing engine 321 may be (at least in part) performed by the event eligibility engine 320 and/or the dynamic resource engine 322.

The pre-processing engine 321 may have or otherwise be associated with a library, catalog, or listing of rules having one or more subrules. The rules of the pre-processing engine 321 may include a checklist or other reference that may be applied to simplify the calculation of the dynamic resource engine 322. The rules may be at least partially standardized in that the checklist or other reference may be input by an operator based upon business logic, client preferences.

The dynamic resource engine 322 is generally configured to determine resource collections for events. In this regard, the dynamic resource engine 322 can determine a resource collection, from among a set of resource collections, that can support or provide resources in association with an event or set of events (e.g., eligible events). A resource collection, as used herein, refers to a collection or set of resources (e.g., funds) that can be used to support an event(s). In embodiments, a resource collection can be a cash pool that funds various events. In this regard, a resource collection can be used to pay a seller of goods and/or services purchased by a buyer. In embodiments described herein, a resource collection can be used to pay a seller of goods and/or services in accordance with modified event data. In this regard, a resource collection may fund a payment due to a seller, for example, at an earlier date for a lesser payment amount (or at a later date for a greater payment amount). A resource collection may be provided by a resource provider. As previously described, a resource provider refers to an entity, such as an organization or individual, that provides resources (e.g., monetary funds). As described herein, a resource provider may be a buying entity or a third-party entity. A buying entity is an entity that purchases goods and/or services from a selling entity, or supplier. A buying entity is a party of an event (e.g., a resource transfer or financial transaction). A third-party entity refers to an entity, such as an organization, that is not a party of an original event (e.g., financial transaction or agreement), but provides resources to one entity associated with the original event on behalf of the other entity associated with the original event. For example, a third-party funder may provide financial resources to a selling entity on behalf of a buying entity. A third-party entity, such as a third-party funder, may be a bank or other business or organization.

Advantageously, multiple candidate resource collections to provide resources for an event(s) enables more opportunities for improved cash flow to selling entities via early invoice payment. By paying selling entities early, either via a buying entity or third-party entity, liquidity can be provided to the supply chain, or selling entity, while preserving cash. Enabling multiple candidate resource collections to be available to support (e.g., fund) events provides more sellers to access early payment, thereby improving seller liquidity within a supply chain, while also improving financial metrics. At a high level, the dynamic resource engine 322, as described in embodiments herein, allows sellers to select buyer invoices desired to be accelerated and determine discounts offered on each one. Early payment of the invoices may be provided by the buyer or third-party entities (e.g., banks). Availability of third-party entities to support or fund events can ensure that funding is available to support early payment to sellers, thereby increase participation rates among selling entities.

To determine resource collections for events, the dynamic resource engine 322 may include a stack generator 330, a modification request identifier 332, a resource collection identifier 334, and a modification request authorizer 336. Such components may be embodied as a set of compiled computer instructions or functions, program modules, computer software services, or an arrangement of processes carried out on one or more computer systems, such as computing device 1000 described in connection to FIG. 10, for example. Any number of components may be used to implement functionality described herein.

The stack generator 330 is generally configured to generate a resource collection stack. A resource collection stack refers to an indication of a set of resource collections that may be available to support an event(s) (e.g., fund a financial transaction having modified terms). As such, in embodiments, a resource collection stack is used to determine a resource collection for an event(s). A resource collection stack may include an indication of resource collections from any number of resource providers. For example, a resource collection stack may include resource collections associated with a buying entity and any number of third-party entities. By way of example, a resource collection stack may include a first resource collection provided by the buying entity, a second resource collection provided by a third-party funder, and a third resource collection provided by another third-party funder. As can be appreciated, a resource collection stack may include any number of resource collections provided by any number of resource providers.

Each resource collection within a resource collection stack can be defined by a set of resource parameters. Accordingly, to generate a resource collection stack, the stack generator 330 can obtain a set of resource parameters for each resource collection within the stack. As used herein, a resource parameter defines a parameter or criteria associated with a resource collection. Resource parameters may include, for example, a resource identifier (e.g., an identification of an entity providing funding), a resource amount (e.g., an amount of cash available), a target rate (e.g., the resource provider's desired return, aggregated across all offers, such as an APR), an event criteria (e.g., invoice criteria, such as timeframe or date of invoice, days-paid-early (DPE), or any other data value/field associated with an invoice), selling entity data (e.g., small and midsize business (SMB), minority owned business, sustainability rating, geographical location, selling entity company size, selling entity company value, or the like), buying entity data, etc. In some cases, resource parameters may be a range. For example, a minimum or maximum amount of time to pay early to suspend the pay.

Such resource parameters associated with resource collections can be obtained by the stack generator 330 in any number of ways. In embodiments, resource parameters can be provided by the resource provider (e.g., buying entity and/or third-party entity) via a graphical user interface of the resource provider device. For example, a buying entity may provide or input, via a graphical user interface, a set of resource parameters for each resource collection being provided by the buying entity. Further, a third-party funder (e.g., a bank) may provide or input, via a graphical user interface, a set of resource parameters for each resource collection being provided by the third-party funder.

As described, each resource collection may be defined using different parameters. For example, a resource provider may provide a first resource collection for a total amount of five million dollars at a target rate of 3% and a second resource collection for ten million dollars at a target rate of 14%. As another example, a resource provider may provide a first resource collection for a total amount of five million dollars for minority-owned selling entities and a second resource collection for a total amount of five million dollars for invoices associated with days-paid-early (DPE) being less than 45 days. To this end, a resource provider may provide any number of resource collections. For instance, a buying entity may provide multiple resource collections and a third-party funder may provide multiple resource collections that are aggregated into a resource collection stack.

Upon obtaining resource parameters in association with various resource collections, the stack generator 330 can generate a resource collection stack that represents the various resource collections. Such a resource collection stack may be stored, for example in data store 326, for subsequent access to determine a resource collection for an event(s).

Any number of resource collection stacks may be generated. For example, in some cases, a resource collection stack corresponds with a particular buying entity. As such, a first resource collection stack may be generated for a first buying entity, a second resource collection stack may be generated for a second buying entity, and so on. In this regard, the stack generator 330 may generate a resource collection stack including indications of resource collections intended in association with a particular buyer. Each resource collection stack may include different resource collections depending on the resources provided by the buying entity and/or third-party entities. By generating a resource collection stack in association with a particular buying entity, a resource collection for events associated with a buyer can be determined using the particular resource collection stack corresponding with the buyer.

In some embodiments, the stack generator 330 may generate and/or update a resource collection stack as resource parameters are obtained. As such, in cases that a resource provider inputs a new resource parameter set for a new resource collection, the stack generator 330 may add the new resource collection to the stack. As another example, in cases that a resource provider updates a parameter (e.g., modifies an amount of cash available), the stack generator 330 can modify the resource parameter for the appropriate resource collection.

In some cases, the stack generator 330 may dynamically (e.g., in real time) generate a resource collection stack for use in determining resource collections. For instance, in accordance with determining a resource collection for a particular event(s), a resource collection stack may be generated for use in making such a determination. The particular resource collections to be included in the resource collection stack may be dynamically determined. For example, a number (e.g., predetermined number) of resource collections associated with a greatest target rate may be selected. As another example, a particular number of resource collections (e.g., one) associated with a buying entity may be selected, and a particular number of resource collections (e.g., two) associated with a third-party entity may be selected. Any number of criteria or factors (e.g., resource parameters) may be used to select which resource collections to include in a resource collection stack.

Resource collection stacks generated via the stack generator 330 may be stored, for example in data store 326, for subsequent use. For instance, and as described in more detail below, a resource collection stack can be referenced and used to determine a resource collection for use in supporting an event(s).

The modification request identifier 332 is generally configured to identify modification requests. A modification request generally refers to a request or offer to modify an event(s), or event data associated therewith. For example, a modification request may relate to an offer to accelerate payment of a financial obligation. A modification request may include or be associated with candidate modification parameters. A candidate modification parameter generally refers to a parameter or attribute (e.g., associated with an event or set of evens) that is offered or provided as a candidate for modifying an event, or data associated therewith. Generally, a candidate modification parameter indicates a modification of an event data/attribute (e.g., amount or date associated with an event, such as a previously agreed upon financial transaction) that an entity is willing to modify. By way of example only, candidate modification parameters may include a payment rate (e.g., discount rate or APR), a discount amount, a number of days to pay early, an indication of the event (e.g., debt) to which the modification applies, and/or the like. A modification request may include other data, such as event data (e.g., a buying entity identifier, a selling entity identifier, an event identifier(s), etc.). In some embodiments, candidate modification parameters may designate a minimum or maximum decrease (or increase) in the financial resources if the event is advanced and/or a total amount of financial resources that will be transferred if the event is advanced. A candidate modification parameter may include a particular currency or a percentage of increase (or decrease) in resources as measured with respect to time, such as an APR. For instance, an entity may configure a range of a minimum to maximum threshold of a 6% to 8% APR return. As can be appreciated, candidate modification parameters may include a range of values. For example, an entity may provide a minimum or maximum amount of time to modify the payment, such as advancing the transfer financial resources from a range between ten to twenty days.

A modification request, including candidate modification parameters, can be obtained in any number of ways, some of which are described herein. As described with reference to FIG. 1, a modification request may be provided by an entity associated with the event. In one embodiment, a selling entity provides a modification request, including a set of candidate event parameters (e.g., via a graphical user interface). Such a modification request and/or candidate modification parameters may be specific to an event data set (e.g., set of events), specific for a buying entity, specific to events meeting some criteria (e.g., an event amount, an event date, etc.). For instance, assume a selling entity is notified of a set of events (e.g., invoices) associated with a buyer that are eligible for event modification. In such a case, a selling entity may provide a modification request, including a candidate modification parameter(s), indicating an event modification that the selling entity desires or offers to be applied to the set of events. By way of example only, assume a buying entity submits a set of invoices totaling one million dollars to be paid to the selling entity in 60 days. In response, the selling entity may provide a modification request including candidate modification parameters indicating a request or offer to receive a payment of $975,000 in 15 days in association with those invoices.

In another embodiment, a modification request and/or candidate modification parameters may be provided by a buying entity (e.g., via a graphical user interface). For example, a buying entity may suggest to pay a reduced amount early (e.g., five percent discount to be paid 30 days early). In such a case, the modification request and/or candidate modification parameters may be accepted, confirmed, or modified by the selling entity.

In yet another embodiment, the dynamic resource manager 308, or other component, may generate a modification request and/or recommended candidate modification parameters. For example, the modification request identifier 332 may generate a recommendation for candidate modification parameters and provide the recommendation to the selling entity. The selling entity may then accept, confirm, or modify such recommended candidate modification parameters. A candidate modification parameter recommendation may be determined based on any data, such as previous candidate modification parameters provided by a selling entity, previous candidate modification parameters accepted or applied, or the like.

Any number of modification requests and/or candidate modification parameters may be identified. For example, for a particular set of events associated with a buyer, multiple selling entities may provide different candidate modification parameters. By way of example only, assume a buyer has 100 invoices corresponding with 20 different sellers. In such a case, any number or portion of the 20 sellers may provide modification requests and corresponding candidate modification parameters. Further, each seller may provide multiple modification requests and/or candidate modification parameter sets. For instance, a seller may provide different candidate modification parameter sets for different events or for different payment rates.

The resource collection identifier 334 is generally configured to identify or determine a candidate resource collection(s) in association with a modification request (e.g., including a candidate modification set). In this regard, for a particular modification request (e.g., having candidate modification parameters), a candidate resource collection(s) is identified. A candidate resource collection generally refers to a resource collection that is a candidate resource for supporting (e.g., funding) a set of events (e.g., associated with a modification request).

In embodiments, the resource collection identifier 334 may initially identify a resource collection stack associated with a modification request. As one example, a modification request may correspond with events associated with a particular buyer. In such a case, a resource collection stack corresponding with that particular buyer may be identified and/or accessed.

The resource collection identifier 334 can then use the resource collection stack to identify or select a candidate resource collection that corresponds with, or matches, an obtained modification request. Generally, to identify a candidate resource collection (e.g., of a resource collection stack), the resource collection identifier 334 analyzes the modification request (e.g., candidate modification parameters) and/or corresponding event data in association with the resource parameters of the corresponding resource collections. In this regard, the resource collection identifier 334 identifies a candidate resource collection having resource parameters that align with, or match, the candidate modification parameters and/or event data (e.g., associated with a modification request). Stated differently, the modification request (e.g., candidate modification parameters) and/or corresponding event data can be analyzed to identify a matching or corresponding resource collection.

In some cases, each of the resource parameters for a resource collection must be met or achieved to identify the resource collection as matching a particular modification request, or candidate modification parameters associated therewith. In other cases, a portion of the resource parameters for a resource collection must be met or achieved to identify the resource collection as matching or aligning with a particular modification request. For example, a minimum rate or amount associated with a modification request may be required to meet or exceed a resource parameter associated with a resource collection. In some implementations, a target rate associated with a resource collection may not need to be exceeded by a particular modification parameter (e.g., APR) to be considered matching. For instance, and as described in more detail herein, a particular candidate rate may not exceed a target rate, but in aggregation with other candidate rates may exceed the target rate.

As can be appreciated, in implementation, a modification request and/or corresponding candidate modification parameters may match multiple resource collections (e.g., via one or more resource parameters). By way of example only, assume a modification request includes a rate of 5%. Further assume that a first resource collection includes a target rate of 3% and a second resource collection includes a target rate of 4%. In such a case, the modification request can be identified to match both the first resource collection and the second resource collection as it exceeds both target rates.

As such, the resource collection identifier 334 may include allocating logic 338 to identify or select a particular candidate resource collection(s) for a modification request and/or candidate modification parameters. Allocating logic 338 may include rules, conditions, associations, classification models, or other criteria, to identify or select a particular candidate resource collection. Allocation logic 338 may take different forms depending on the mechanism used to identify resource collections. For example, allocation logic 338 may comprise a statistical model, fuzzy logic, neural network, finite state machine, support vector machine, logistic regression, clustering, or machine-learning techniques, similar statistical classification processes, or combinations of these to identify resource collections.

Allocating logic 338 may select a candidate resource collection in any number of ways. In one embodiment, allocating logic 338 may employ a waterfall or cascading implementation. In this approach, resource collections of a resource collection stack may be analyzed in succession until a resource collection is identified as matching a particular modification request. In this way, a first resource collection may be analyzed in association with a modification request. If the modification request is identified as matching the first resource collection (e.g., by comparing resource parameters with candidate modification parameters and/or event data), the first resource collection is identified or selected as the matching resource collection. If the modification request does not match the first resource collection, the second resource collection can be analyzed in association with the modification request. The modification request can continue to be analyzed in connection with each successive resource collection (e.g., within a resource collection stack) until a matching resource collection is identified. Such a waterfall approach implements a prioritization for identifying a modification request that matches a resource collection.

As can be appreciated, in some cases, a modification request may continue to be analyzed in connection with successive resource collections even if a matching resource collection is identified. For instance, as described, a modification request may correspond with multiple events (e.g., invoices), with each event have different attributes (e.g., different dates for amounts to be paid, different amounts, etc.). As such, a modification request may be identified to correspond or match with a resource collection for a portion of the events associated with the modification request. As one example, a resource collection may have a resource limit of $1 million and a set of invoices associated with a modification request may exceed $1 million. As another example, a resource collection parameter may indicate that invoices qualifying for that resource may need to be paid within a certain number of days or a time frame (e.g., within the quarter). Accordingly, a modification request may be identified to match multiple resource collections and may do so in a prioritized manner.

The prioritization order for successively descending through the resource collections may be determined in any number of ways. In embodiments, the resource collections may be prioritized based on the corresponding entity. For instance, resource collections associated with the buying entity may be arranged higher in priority than resource collections associated with third-party entities (e.g., bank). Further, third-party entities may be ranked, for instance, based on a relationship with a buyer or supplier, resource parameters, etc. In other embodiments, resource collections may be prioritized using any number of resource parameters. For example, resource amounts, resource discount amounts, days-paid-early, etc. may be used to prioritize, score, or rank the resource collections. Such a prioritization or ranking order may be determined when the resource collection stack is generated or at an execution time when a resource collection is being identified for a modification request.

In another embodiment, allocating logic 338 may employ a distribution-based approach to select a matching candidate resource collection. In this approach, various resource collections may be analyzed to identify a resource collection that matches a particular modification request in association with a distribution goal. In this way, a candidate resource collection may be selected that matches a modification request and also that achieves a distribution goal. As such, allocating logic 338 may determine a set of resource collections that match a modification request (e.g., via a parameter comparison) and select one of the matching resource collections as a candidate resource collection based on a distribution goal. In this regard, the allocating logic 338 may analyze distribution of previous modification requests to matching resource collections to select a particular resource collection for a modification request.

A distribution goal may be any goal intended to result in a specified distribution of modification requests among resource collections. Distribution goals may be based on any number of aspects including, for example, resource parameters (e.g., resource amounts, resource target rates, etc.), selling entity preferences, resource provider preferences, historical resource collection usage (e.g., resource collection recently used or not recently used, average use over a period of time), and/or the like. As one example, a distribution goal may relate to an equitable distribution among resource collections (e.g., defined by an entity or managing entity of the dynamic resource manager). For instance, if a particular resource collection has not been selected in association with other modification requests within some timeframe (e.g., a predetermined time threshold), the resource collection may be selected. As another example, a particular percent or amount of resources of a resource collection may be desired to be fulfilled in each resource collection before increasing use of a resource collection. For instance, each resource collection may be required to use 20% of resources, or $5 million of resources, before increasing use of one of the resource collections beyond a specified threshold.

In another embodiment, allocating logic 338 may employ a direct allocation-based approach to select a matching candidate resource collection. In this approach, various resource collections may be analyzed to identify a resource collection that matches a particular modification request. In this way, a candidate resource collection may be selected that “best” matches a modification request. As such, allocating logic 338 may determine a set of resource collections that match a modification request (e.g., via a parameter comparison) and select a “best” resource collections as a candidate resource collection based on some criteria (e.g., a highest or lowest APR, a highest or lowest days paid early, etc.). In this regard a set of rules may be employed to direct allocation of a modification request to a candidate resource collection.

Other approaches may additionally or alternatively be used to select a particular candidate resource collection matching a modification request. For instance, selection of a particular candidate resource collection may be a random selection from among matching resource collections. Further, although generally described as initially identifying a particular candidate resource collection, in embodiments, multiple candidate resource collections may be identified (e.g., each resource collection identified as matching, etc.). In such cases, the modification request may be routed to multiple candidate resource collections for analysis in succession or concurrently. For instance, a modification request may be analyzed for a first candidate resource collection in connection with a first portion of events, and the modification request may also be analyzed for a second candidate resource collection in connection with a second portion of events. In some cases, a same modification request may be analyzed for both candidate resource collections. In other cases, a particular modification request may be duplicated or new modification requests may be generated to be analyzed for the separate candidate resource collections. For instance, assume a modification request is received in association with 20 events. Further assume that it is determined that a first portion of the 20 events corresponds with a first candidate resource collection and a second portion of the 20 events corresponds with a second candidate resource collection. In such a case, new corresponding modification requests may be generated (e.g., one for the first portion of events corresponding with the first candidate resource collection and another for the second portion of events corresponding with the second candidate resource collections). As can be appreciated, candidate modification parameters (e.g., as specified by a selling entity) may be the same for both modification requests.

The modification request authorizer 336 generally determines whether to authorize, approve, or accept modification requests, or candidate modification parameters, in association with candidate resource collections. In accordance with authorizing or approving a modification request in connection with a candidate resource collection, the candidate resource collection can be designated for use in supporting the corresponding event. As described above, the modification request matches the candidate resource collection to which it is allocated. As such, in some implementations, the modification request authorizer 336 may automatically approve modification requests in association with the matching candidate resource collection.

In other implementations, the modification request authorizer 336 may determine which of multiple modification requests, or events associated therewith, to approve for a particular candidate resource collection. For example, as can be appreciated, many modification requests may correspond or match with a particular resource collection. The resource collection, however, may not be able to provide resources in association with each of the modification requests. For instance, in some cases, the amount of resources offered in association with a resource collection (e.g., five million) may not cover the amount of resources needed for events associated with multiple modification requests that align with the resource collection (e.g., a first modification request from a first selling entity and a second modification request from a second selling entity). As such, the modification request authorizer 336 may determine which modification requests, and/or events associated therewith, to authorize or approve for a resource collection(s).

In some cases, resource collector authorizer 336 may use resource parameters associated with a resource collection to determine which modification requests to authorize for use of the corresponding resources. By way of example, a set of modification requests attaining a target APR identified via a resource parameter may be approved. In this way, a market auction may be conducted to meet or exceed a target parameter. For instance, assume a target APR associated with a resource collection is 10%. Further assume a first modification request includes a candidate modification parameter of 12%, a second modification request includes a candidate modification parameter of 7%, and a third modification request includes a candidate modification parameter of 9%. In such a case, the first modification request and third modification request may be selected to meet the target APR of 10%. As can be appreciated, the resource collector authorizer 336 may determine or select modification requests that optimize monetary return (maximum discount value) while maintaining an APR return that is at or above a desired or targeted yield. As another example, modification requests associated with highest payment rates or earliest payment dates may be approved (up through a designated threshold resource amount).

As can be appreciated, the resource collection identifier 334 and the modification request authorizer 336 may interactively or iteratively operate. For example, assume a modification request is initially assigned or allocated to a first candidate resource collection via the resource collection identifier 334. Further assume that the modification request is not accepted or approved via the modification request authorizer 336 (e.g., fails to aggregate with other modification requests to meet a target APR). In such a case, the resource collection identifier 334 may assign or allocate the modification request to a second candidate resource collection (e.g., based on a waterfall approach or a distribution goal approach). As another example, assume a modification is initially assigned or allocated to a first candidate resource collection via the resource collection identifier 334. Further assume that the modification request is accepted or approved via the modification request authorizer 336 for a portion of events associated with the modification request (e.g., a portion of events associated with the modified request are below an resource amount for the resource or a portion of events meet a resource parameter designated for the resource collection). In such a case, the resource collection identifier 334 may assign or allocate the modification request (or an associated request) to a second candidate resource collection that is identified to match the modification request.

Further, aspects of dynamic resource engine 322 may be initiated or executed at any time. For example, such components may operate as modification requests are received. As another example, modification requests may be collected and, at a certain time, the components operate to dynamically determine resource collections for events. For instance, an execution time may be designated on a daily basis such that the processes employed via dynamic resource engine 322 operate at the designated execution time.

The event modification engine 324 is generally configured to modify, or initiate modification of, event data associated with events. In particular, in accordance with authorized or approved modification requests, the event modification engine 324 can initiate modification of corresponding event data.

As described, a modification request may be associated, either directly or indirectly, with a set of events. For instance, a modification request may be provided in response to a set of eligible events being identified. In cases that a modification request (and/or events) is authorized or approved for a particular resource collection, event data associated with the corresponding events can be identified and modified in accordance with the modification request (e.g., candidate modification parameters).

In this regard, based on an authorized modification request, the event modification engine 324 may identify and access event data (e.g., event records or invoices) associated with the modification request. Event data may be accessed, for example, from a data store such as data store 326. In some cases, all events associated with a modification request may be identified. In other cases, some events associated with a modification request may be identified. For instance, based on resource parameters, events that meet such resource parameters may be selected. For instance, assume a resource collection has a resource amount of one million dollars. In such a case, events associated with up to one million dollars may be identified.

The event modification engine 324 can then trigger or initiate modification of event data, or portions thereof. In this regard, event data can be modified or updated in accordance with the authorized modification request and/or modification parameters associated therewith. The event modification engine 324 may perform the event data modifications and/or instruct another component (e.g., a component of an electronic resource management system) to make such event data modifications.

At a high level, event modification engine 324 may utilize event data and/or modification parameters to determine event modifications. Event modifications generally refer to a manner in which event data should be modified. Based on a determination of how to modify event data, event modification engine 324 can generate an instruction to initiate event data modification (e.g., via the event modification engine 324 or a remote component or system). In some cases, event data modification may include updating event data(s), for example, within an event record. In other cases, event data modification may include generating new event data and/or new event records associated with an event. In yet other cases, event data modification may include providing an indication of an increase or a decrease data (e.g., amount). For example, instead of instruction to modify event data to indicate a particular payment amount, the event data modification instruction may indicate an amount to decrease resources paid in connection with a financial transaction. An electronic resource management system obtaining the payment reduction indication could then modify the event data to reflect the payment reduction.

Event data modification may be applicable to any type of event data. By way of example only, event data modification may effectuate an increase (or decrease) of resources to be transferred and/or a time in which the resource transfer will occur. As another example, event data being updated or modified may reflect the paying entity. For example, in cases that a resource collection associated with a third-party entity is selected to fund a financial transaction, the event data may be modified to reflect payment provided by the third-party entity.

As described, the event modification engine 324 can determine event data to modify and then initiate, via an instruction, the modification of information about the event, for example, in electronic resource management systems and/or computing devices. For instance, event modification engine 324 may instruct electronic resource management systems and/or computing devices to include new event data (e.g., modify existing event data and or generate new event data). As described herein, entities conventionally utilize non-integrated or disparate electronic resource management systems to maintain data associated with an event. For example, a buying entity may utilize one electronic resource management system and a selling entity may utilize another electronic resource management system. This presents technological problems since modifications to event data in one electronic resource management system are not reflected in another electronic resource management system. In addition to other components of system 300, event modification engine 324 may assist in overcoming technological problems associated with whether data in non-integrated or disparate electronic resource management systems or computing devices should be modified.

In embodiments, the event modification engine 324 may include an electronic resource management software instructor configured to instruct an electronic resource management system (or other system) to include information about the modified event so as to reconcile event data across one or more electronic resource management systems. For example, upon identifying a manner in which to modify event data, resource management software instructor may communicate with the appropriate electronic resource management systems to effectuate the event data modification within the electronic resource management systems. In this regard, resource management software instructor may cause an electronic resource management system to include information about the modified event. For instance, resource management software instructor may instruct an electronic resource management system to modify previously stored data files for the event or generate new data files for the event. Based on determining a manner in which to modify events, resource management software instructor may generate instructions including information about the modifications of the event and communicate those instructions to an electronic resource management system associated with one or more entities (and, in some instances, all of the entities) associated with the event. For example, an instruction may be communicated to a buying entity, a selling entity, and a third-party funding entity.

In some cases, each instruction may be different to specifically modify event data associated with the corresponding entity. For example, a buying entity may notified to pay the third-party funding entity for the original amount on the original payment due date. The third-party funding entity may be notified to pay the selling entity a reduced monetary amount on an earlier payment date. The selling entity may be notified that the selling entity is paying a reduced monetary amount on the earlier payment date.

In this regard, resource management software instructor may generate instructions that are specific to an entity's electronic resource management system. There may be different and/or disparate electronic resource management systems. Resource management software instructor may account for these differences and generate instructions that are consumable by the electronic resource management system utilized by a particular entity. In some aspects, resource management software instructor determines instructions based on identifying the entities associated with the event and cross-referencing a database storing an indication of the electronic resource management associated with that entity. Resource management software instructor may then provide instructions in a protocol or format that is consumable by the electronic resource management.

In some aspects, resource management software instructor may provide instructions in the form of an event file. The event file may identify one or more events that has been modified. The event file may also provide an indication of the event data associated with modifying the event.

In some aspects, resource management software instructor may provide instructions utilizing an application interface that is particular to the electronic resource management system. To this end, the resource management software instructor may generate instructions in the form of an application program interface (API) call to modify event data. The API call may provide an indication of the event data associated with modifying the event.

Resource management software instructor may provide information that identifies the event to be suspended (e.g., using an event ID) and information regarding what data stored within memory of an electronic resource management system is to be modified. In some embodiments, resource management software instructor may instruct an electronic resource management system to modify an existing data file of an event (e.g., the unmodified or original event) with new event data associated with the modified event. As used herein, the term modify is meant to be interpreted broadly and may include updating an existing record and/or deleting an existing record along with creating a new record. The instructions may include any information associated with modifying the event, such as an amount of resources that are to be transferred as indicated by a resource indicator, a scheduled time for reconciling the event, an event ID, entities associated with the event, or the like.

In example embodiments, a first electronic resource management system may include first event data in a first data file. The first data file may include event data that identifies a scheduled time for reconciling the event based on an inbound resource. Similarly, a second electronic resource management system may include event data stored in a second data file. The second data file may include a scheduled time for reconciling the same event based on an outbound resource. Based on determining that the event has been modified, resource management software instructor may instruct the first electronic resource management system to modify the first data file in the first electronic resource management system and the second data file in the second electronic resource management system.

Continuing, resource management software instructor may instruct the first electronic resource management system to modify event data that is stored within its system. In some embodiments, resource management software instructor may instruct the first electronic resource management system to modify the resource indicator from a first amount of inbound resources to a second amount of inbound resources. In some embodiments, the second amount of inbound resources may be lower than the first amount of inbound resources. Resource management software instructor may also instruct the first electronic resource management system to modify the event data to modify the scheduled time for reconciling the event (e.g., by transferring resources) from a first time to a second time. In some embodiments, the second time precedes the first time.

Similarly, resource management software instructor may instruct the second electronic resource management system to modify event data stored in its system. In some embodiments, resource management software instructor may instruct the second electronic resource management system to modify the resource indicator from a first amount of outbound resources to a second amount of outbound resources. In some embodiments, the second amount of outbound resources may be lower than the first amount of outbound resources. Resource management software instructor may also instruct the second electronic resource management system to modify the scheduled time for reconciling the event from the first time to the second time.

Continuing with example technologies employed in a financial industry, resource management software instructor may cause one or more electronic resource management systems, such as the buyer's and/or the supplier's electronic resource management system, to modify event data associated with a particular payment. For instance, resource management software instructor may instruct a buyer's electronic resource management system to modify a payment that is stored in a data file having account payable information from $1,000 to $900. Resource management software instructor may also instruct the buyer's electronic resource management system to modify the payment date from Aug. 1, 2020 to Jul. 1, 2020. Similarly, resource management software instructor may instruct the supplier's electronic resource management system to modify a payment that is stored in a data file having account receivable information from $1,000 to $900. Resource management software instructor may also instruct the supplier's electronic resource management system to modify the payment date from Aug. 1, 2020 to Jul. 1, 2020. As stated herein, while particular reference has been made to financial resources, the improvements provided by the technologies are not limited to the financial industry but can be utilized in many different industries.

In aspects where an event is modified in accordance with resources being provided through a third-party entity, resource management software instructor may instruct the relevant electronic resource management systems to store an indication that the resource is being rerouted through a third-party entity. In particular, resource management software instructor may instruct electronic resource management systems associated with a first and second entity to modify a data file of the modified event to indicate that the resources will be transferred to (or from) the third-party entity. For example, the first and second electronic resource management systems may initially store an indication that the resource will be transferred to (or from) the first and second entity. In particular, a first electronic resource management system maintained by a computing device associated with the first entity may initially store an indication that the resource transfer is an outbound resource having a destination ID associated with the second entity. A second electronic resource management system maintained by a computing device associated with the second entity may store an indication that the resource transfer is an inbound resource having a source ID associated with the first entity. Resource management software instructor may instruct the first and second electronic resource management systems to modify the data file to indicate that the resources associated with the event have been rerouted. For example, the first electronic resource management system can modify the destination ID associated with the second entity to a destination ID associated with the third-party entity. Resource management software instructor may also provide separate instructions to the second electronic resource management system to modify the source ID associated with first entity to a source ID associated with the third-party entity. It should be appreciated that the resource management software instructor may instruct the first and second electronic resource management systems to store an indication of other event data associated with rerouting the resources through the third-party entity (e.g., schedule date of the resource transfer, amount of resources being transferred, event ID, or the like). Further, resource management software instructor may also instruct a third electronic resource management systems to include a data file to indicate that the resources will be rerouted through the third-party entity.

It should be appreciated that rerouting the resources through the third-party entity may be associated with two rerouting events. The first rerouted event may include the transfer of resources from the first entity to the third-party entity. The second rerouted event may include the transfer of resources from the third-party entity to the second entity. Regarding the first rerouted event, resource management software instructor may instruct the first electronic resource management systems to include (e.g., generate) a data file to indicate that a resource will be transferred from the first entity to the third-party entity. In particular, the third electronic resource management system may be instructed to include a data file that an inbound resource will be transferred from a source ID associated with the first entity. It should be appreciated that the resource management software instructor may instruct the third electronic resource management system to store an indication of other event data associated with the first rerouted event (e.g., schedule date of the resource transfer, amount of resources being transferred, event ID, or the like).

Regarding the second rerouted event, the resource management software instructor may instruct the third electronic resource management system to include (e.g., generate) a data file indicating that a resource will be transferred from the third-party entity to the second entity. In particular, the third electronic resource management system may be instructed to include a data file of an event associated with transferring an outbound resource to a destination ID associated with the second entity. The resource management software instructor may further instruct the third electronic resource management system to include other event data associated with the second rerouted event (e.g., schedule date of the resource transfer, amount of resources being transferred, event ID, or the like).

While not shown, event modification engine 324 may also include components that automatically facilitate the event (e.g., financial transaction) according to the modified event data. For example, event modification engine 324 may automatically debit a buyer's financial account (e.g., a bank account) to execute the payment according to the decreased (or increased) payment amount and/or the early (or suspended) payment date. Additionally or alternatively, event modification engine 324 may automatically issue a payment from a buyer's financial institution to a supplier's financial account according to the decreased (or increased) payment amount and/or the early payment date. Additionally or alternatively, event modification engine 324 may automatically issue a payment to and/or from a financing party's financial institution.

In embodiments, and as described, the event modification engine 324 communicates with an electronic resource management system to effectuate modification of event data. Although not illustrated, generally, an electronic resource management system, or other data source, can receive instructions and modify stored event data. For example, event modification engine 324 may communicate with an electronic resource management system (e.g., associated with a buying entity, selling entity, or resource provider) so as to indicate which events have been modified (and/or information regarding a modified event) and modify event data. For example, resource management software instructor can provide instructions to an electronic resource management system that includes information that identifies the event to be modified (e.g., using an event ID) and information regarding how it is to be modified. In some embodiments, an electronic resource management system may modify an existing record of event with new event data. As stated, the instructions may include any information associated with modifying the event, such as an amount of resources that are to be transferred so as to reconcile the event, a scheduled time for reconciling the event, an event ID, entities associated with the event, source ID and/or destination ID, or the like.

In some embodiments, electronic resource management system can receive instructions in the form of an event file and extract event information about a modified event. Performing such an extraction may be a modification to a layer (e.g., application layer) of the electronic resource management system. For instance, in order to on-board an entity's system, an entity may be provided a script of command instructions that are specific to entity's electronic resource management system. The command instructions may modify the layer (e.g., application layer) of the electronic resource management system. This may allow the system 300 to integrate and communicate with a variety of electronic resource management systems. In some embodiments, the command instructions alter an inbound and/or outbound component of an adapter for the electronic resource management system (e.g., an SAP adapter). For instance, the command instructions may alter how an electronic resource management system accesses an application server that is in communication with the resource management software instructor.

The electronic resource management system may extract event data from an event file communicated by the resource management software instructor. For example, the event file may include information about one or more events that have been modified. Among other information, the event file may include information for modifications to an amount of resources that are to be transferred so as to reconcile the event. For instance, the event file may include information for an updated amount of resources that will be transferred based on modifying the event. In some embodiments, modifying the event data may require a decrease in the amount of resources. Additionally or alternatively, the event file may include information about a modified scheduled time for transferring the resources. The event file may further include other information associated with the event, such as an event ID, identifying the resources as inbound or outbound, entities associated with the event, or the like. The electronic resource management system may thus extract event data from the event file and instruct modifying one or more databases accordingly. In some embodiments, the event file is communicated on a daily, weekly, or monthly basis. For example, events associated with a 24 hour period may be compiled. Resource management software instructor may then generate an event file for the one or more modified events on a weekly basis. The event file may then be communicated on a weekly basis.

It should be appreciated that technical problems exist in integrating electronic resource management systems. Conventionally, electronic resource management systems may be third-party systems that are implemented on a user computing device. Third-party electronic resource management systems may restrict the level of access to manipulate an electronic resource management system's software components. By performing extraction, a third-party electronic resource management system may be adapted to receive instructions in the form of an event file, which may avoid having to gain the level of access necessary to manipulate an application layer of a third-party electronic resource management system.

Electronic resource management systems may include an application interface. Application interface, in general, receives an instruction to modify event data via a network connection and/or an application program interface (API). In embodiments utilizing an API, application interface may receive an API call having instructions to modify event data. Among other information, the API call may include information for modifications to an amount of resources that are to be transferred so as to reconcile the event. For instance, the API call may include information for an updated amount of resources that will be transferred based on modifying the event. In some embodiments, modifying the original event may require a decrease (or increase) in the amount of resources needed to reconcile the event that has been delayed. Additionally or alternatively, the API call may include information for a modified scheduled time for reconciling the event. Additionally or alternatively, the API call may include other information in order for the electronic resource management system to modify stored event data, such as an event ID, identifying the resources as inbound or outbound, entities associated with the event, or the like.

Conventionally, electronic resource management systems may be third-party systems that are implemented on a user computing device. Some third-party electronic resource management systems allow access to implement an application program interface within an electronic resource management system's software components. It should be appreciated that application interface overcomes difficulty in integrating third-party electronic resource management systems as it allows a third-party's electronic resource management system to communicate with other components of system 300. Additionally or alternatively, application interface may limit technical problems of delaying the modification of data within the third-party electronic resource management system because application interface may modify event data in near real-time, such as when it is determined that an event is modified. Additionally or alternatively, application interface may overcome technical problems as it may allow disparate electronic resource management systems from the same commercial vendor. For example, application interface allows electronic resource management systems from the same vendor to communicate over a network to determine which events have been modified and the information associated with the suspended event.

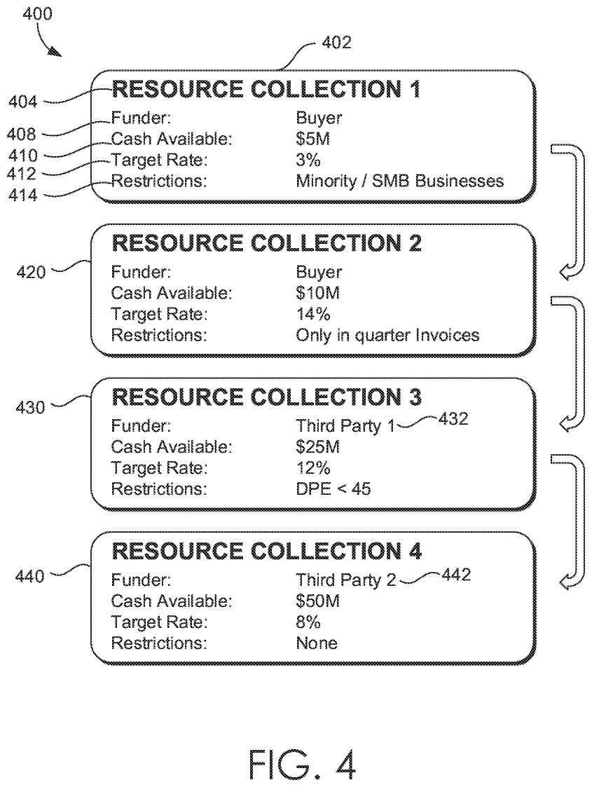

By way of example only, and with reference to FIG. 4, FIG. 4 provides an example set of resource collections 400 (e.g., a resource collection stack) for use in performing allocation of a modification request to a candidate resource collection using a waterfall approach. As shown, each resource collection includes a set of resource parameters defining the resource collection. For example, resource collection 402 includes a resource collection identifier 404, a resource provider 406, a resource amount available 408, a target rate 410, and resource attributes 412. Resource parameters may vary for each resource collection.

Assume that a modification request is received from a large entity (e.g., a selling entity) indicating an offer to discount a set of invoices (totaling ten million) by 14% in return for early payment. In allocating or assigning the modification request to a candidate resource collection, the first, or top, resource collection 402 is analyzed in accordance with the modification request. In this example, resource collection 402 provides five million in cash with a target rate of 3% APR (e.g., as an average). To qualify for this resource collection 402, the selling entity must be a minority-owned business or a small business. As the modification request corresponds with a large entity that is not minority owned, the modification request does not qualify for resource collection 402.

With the waterfall approach, the next resource collection, resource collection 420, is analyzed in accordance with the modification request. In this example, resource collection 420 provides ten million in cash with a target rate of 14% APR (e.g., as an average). Resource collection 420 also requires invoices to be due in the present quarter in order to be considered for funding. Assume that five million (of the ten million associated with the modification request) are due in the current quarter. As the target rate criteria is met in resource collection 420, five million of the invoices qualify for resource collection 420. In this case, the buyer entity will pay a 14% discount on the five million dollars to the seller entity at an early payment date. In this regard, an instruction can be communicated to the buyer entity's ERP system to change the due date to be paid immediately and change the amount to the discounted price.

With regard to the remaining five million in invoices, the next resource collection, resource collection 430, is analyzed in accordance with the modification request. As shown, resource collection 430 is funded by a first third-party entity 432. Resource collection 430 provides $25 million in cash with a target rate of 12% APR (e.g., average). Resource collection 430 also requires days paid early to be less than 45 days. Assume that $2.5 million associated with the remaining invoices satisfy this criteria of less than 45 days paid early. As such, the first third-party entity 432 will pay a 14% discount on the $2.5 million to the seller at an early payment date. In this way, an instruction can be communicated to the third-party entity to notify the third-party entity to pay the discounted price at an early payment date. Another instruction can be communicated to the buyer entity to notify the buyer entity to change payment of the $2.5 million to the first third-party entity 432 at the original date.

Resource collection 440, funded by a second third-party entity 442, is then analyzed in accordance with the final $2.5 million associated with the invoices. As any criteria associated with the resource collection 440 appears to be met, the final $2.5 million is funded by the second third-party entity 442.

As can be appreciated, even though a set of invoices may meet criteria associated with a particular resource collection, in some cases, a corresponding modification request must also be authorized prior to selection of that particular resource collection. For example, in some cases, the amount of resources offered in association with a resource collection (e.g., five million) may not cover the amount of resources needed for invoices associated with multiple modification requests. As such, in some cases, a set of invoices associated with discounts that meet or exceed a target APR identified may be approved. In this way, a market auction may be conducted to meet or exceed a target parameter.

To select or authorize particular invoices, a market auction make take into account how much cash is available, the target rate, and a minimum rate offered for funding. For example, assume a first seller entity submits an offer at 12%. In cases that the offer meets resource parameters associated with a first resource collection, the offer is analyzed for authorization or selection in accordance with a market auction. Now assume that the offer of 12% is not authorized or selected for the first resource collection. For instance, first resource collection may correspond with a target rate of 14%, and the 12% offer in combination with other offers is not high enough to surpass the target rate of 14%. In cases in which a qualified set of invoices are not authorized following a market auction, such invoices can be analyzed in the subsequent second resource collection being analyzed. Now assume that a second seller entity submits an offer at 16%. In such a case, the 12% offer from the first seller entity may be authorized in connection with the first resource collection as the 16% and the 12% meet the target rate of 14%. It should be appreciated that, in some embodiments, an offer, and/or invoices associated therewith, may not individually satisfied a target rate threshold. However, by aggregating the offers, and/or invoices associated therewith, the aggregated offers/invoices might be authorized that might not have otherwise been authorized on an individual basis.

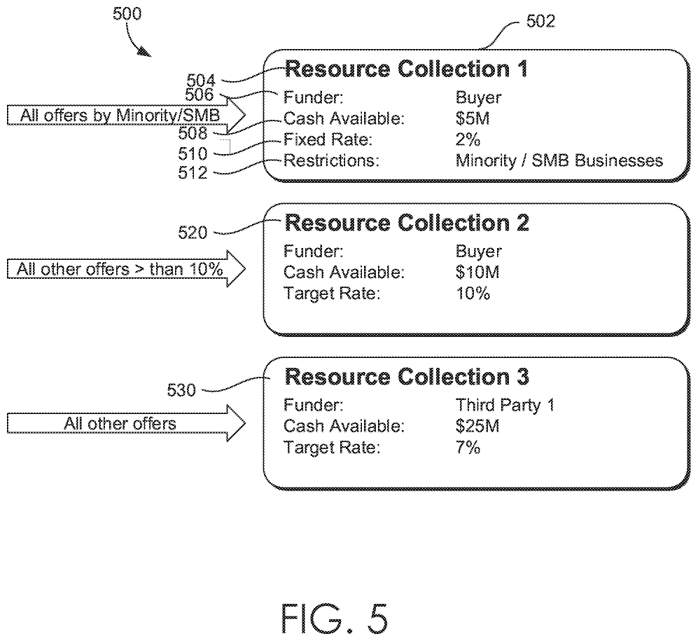

FIG. 5 provides an example set of resource collections 500 (e.g., a resource collection stack) for use in performing allocation of a modification request to a candidate resource collection using a direct routing approach. As shown, each resource collection includes a set of resource parameters defining the resource collection. For example, resource collection 502 includes a resource collection identifier 504, a resource provider 506, a resource amount available 508, a rate 510, and resource attributes 512. Resource parameters may vary for each resource collection.

In this example, assume a buyer desires to fund up to $5 million of small and medium businesses (SMB) at exactly 2% APR, via resource collection 502, and up to $10 million of other sellers at rates greater than 10%, via resource collection 520. In such a case, non-SMB offers less than 10% would be routed or allocated to resource collection 530 to be funded by a third party.

With direct routing, rather than having offers analyzed in association with resource collections in succession, offers can be directly routed to the resource collection that is most aligned or fitted. In some embodiments, when the offer is not authorized at the selected resource collection, the offer may be analyzed in association with another resource collection. In other embodiments, when the offer is not authorized at the selected resource collection, the offer is not further analyzed.

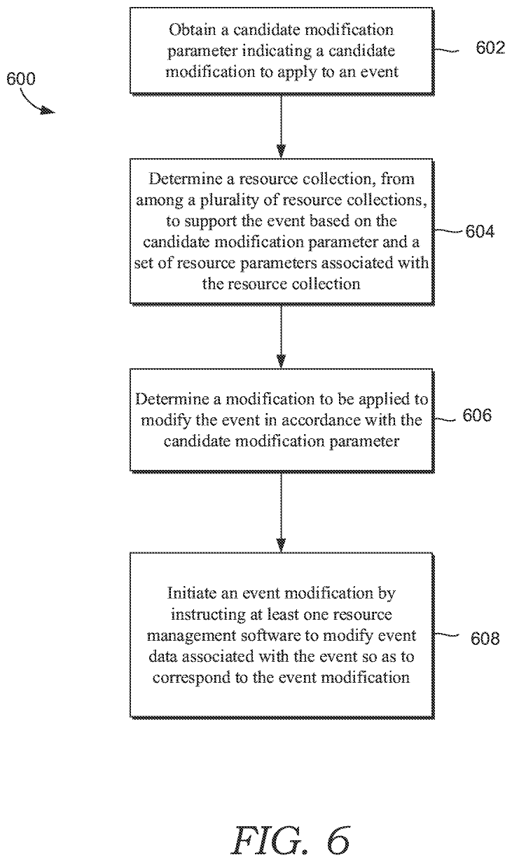

Turning to FIGS. 6-9, FIGS. 6-9 provide illustrative method flows for facilitating dynamic resource management, in accordance with embodiments described herein. FIG. 6 provides one example flow 600 that may be implemented to facilitate dynamic resource management. Initially, at block 602, a candidate modification parameter indicating a candidate modification to apply to an event is obtained. In embodiments, a candidate modification parameter may be obtained via a modification request. The candidate modification parameter may be input via a graphical user interface by a selling entity. In response to obtaining the candidate modification parameter, a resource collection is determined, from among a plurality of resource collections, to support the event based on the candidate modification parameter and a set of resource parameters associated with the resource collection, as indicated at block 604. For example, the candidate modification parameter may be compared to the set of resource parameters to determine if a match or alignment exists. Thereafter, at block 606, a modification to be applied to modify the event in accordance with the candidate modification parameter is determined. The modification to be applied to modify the event may be the candidate modification parameter or a value derived therefrom. At block 608, an event modification is initiated by instructing at least one resource management software to modify event data associated with the event so as to correspond to the event modification. For instance, resource management software associated with a buying entity, selling entity, and/or third-party entity may be provided with instructions.

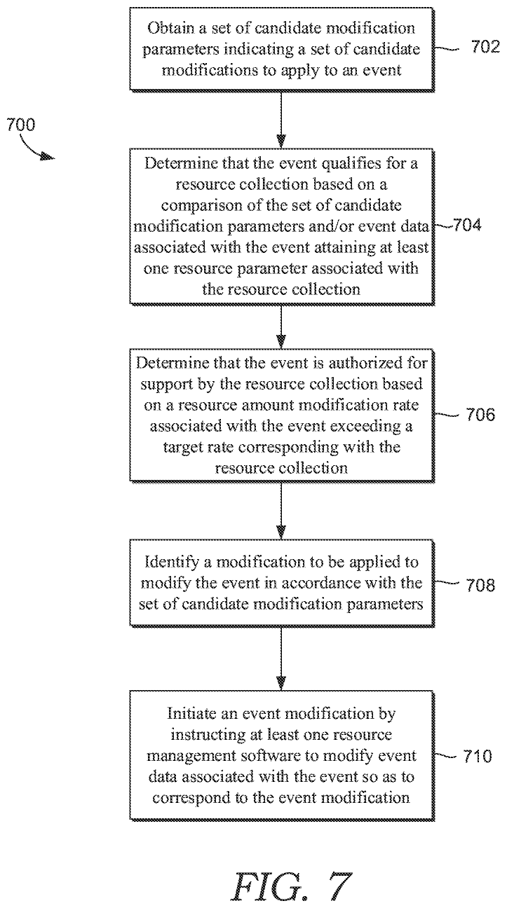

FIG. 7 provides another example flow 700 that may be implemented to facilitate dynamic resource management. Initially, at block 702, a set of candidate modification parameters indicating a set of candidate modifications to apply to an event is obtained. In embodiments, the set of candidate modification parameters includes at least a resource amount modification rate. At block 704, it is determined that the event qualifies for a resource collection based on a comparison of the set of candidate modification parameters and/or event data associated with the event attaining at least one resource parameter associated with the resource collection. At block 706, it is determined that the event is authorized for support by the resource collection based on a resource amount modification rate associated with the event exceeding a target rate corresponding with the resource collection. Thereafter, at block 708, a modification to be applied to modify the event in accordance with the set of candidate modification parameters is identified. At block 710, an event modification is initiated by instructing at least one resource management software to modify event data associated with the event so as to correspond to the event modification.

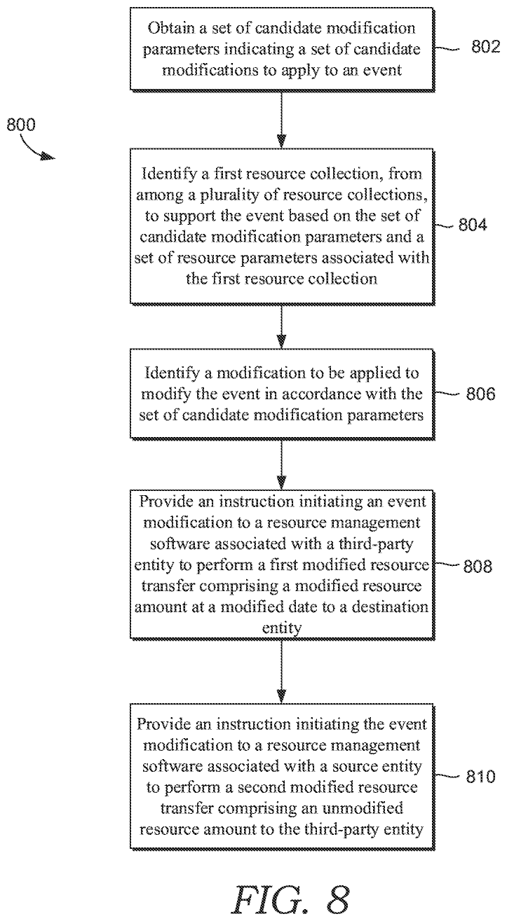

FIG. 8 provides another example flow 800 that may be implemented to facilitate dynamic resource management. Initially, at block 802, a set of candidate modification parameters indicating a set of candidate modifications to apply to an event is obtained. At block 804, a first resource collection is identified, from among a plurality of resource collections, to support the event based on the set of candidate modification parameters and a set of resource parameters associated with the first resource collection. In embodiments, the plurality of resource collections includes the first resource collection associated with a third-party entity that is willing to provide a resource transfer associated with the event on behalf of a source entity and a second resource collection associated with the source entity that is initially to provide the resource transfer in association with the event. At block 806, a modification to be applied to modify the event in accordance with the set of candidate modification parameters is identified. Thereafter, at block 808, an instruction initiating an event modification is provided to a resource management software associated with a third-party entity to perform a first modified resource transfer comprising a modified resource amount at a modified date to a destination entity. At block 810, an instruction initiating the event modification is provided to a resource management software associated with a source entity to perform a second modified resource transfer comprising an unmodified resource amount to the third-party entity.

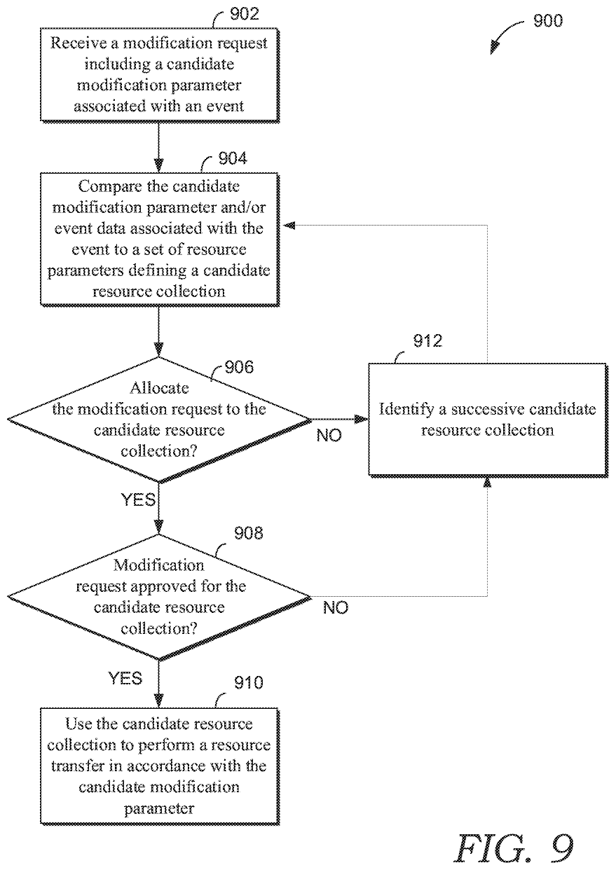

FIG. 9 provides another example flow 900 that may be implemented to facilitate dynamic resource management. Initially, at block 902, a modification request including a candidate modification parameter associated with an event is received. At block 904, the candidate modification parameter and/or event data associated with the event are compared to a set of resource parameters defining a candidate resource collection. At block 906, it is determined whether the modification request should be allocated to the candidate resource collection based on the comparison. If so, a determination is made as to whether the modification request is approved for the candidate resource collection. This is indicated at block 908. In some embodiments, an approval can be determined based on an analysis as to whether a target rate associated with the candidate resource collection is exceeded (either alone or in combination/aggregation) in connection with an APR associated with the modification request. If the modification request is approved for the candidate resource collection, at block 910, the candidate resource collection can be used to perform a resource transfer in accordance with the candidate modification parameter.

Returning to block 906, if it is determined that the modification request should not be allocated to the candidate resource collection, a successive candidate resource collection is identified, as indicated at block 912. The process then returns to block 904 at which the candidate modification parameter and/or event data associated with the event are compared to a set of resource parameters defining the candidate resource collection. Such a process can iterate until the modification request is approved for a particular candidate resource collection and the resource transfer is performed in accordance with the candidate modification parameter.

Having described various embodiments of the disclosure, an exemplary computing environment suitable for implementing embodiments of the disclosure is now described. With reference to FIG. 10, an exemplary computing device is provided and referred to generally as computing device 1000. The computing device 1000 is but one example of a suitable computing environment and is not intended to suggest any limitation as to the scope of use or functionality of the disclosure. Neither should the computing device 1000 be interpreted as having any dependency or requirement relating to any one or combination of components illustrated.

Embodiments of the disclosure may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the disclosure may be practiced in a variety of system configurations, including handheld devices, consumer electronics, general-purpose computers, more specialty computing devices, or the like. Embodiments of the disclosure may also be practiced in distributed computing environments where tasks are performed by remote-processing devices that are linked through a communications network. In a distributed computing environment, program modules may be located in both local and remote computer storage media including memory storage devices.

With reference to FIG. 10, computing device 1000 includes a bus 1010 that directly or indirectly couples the following devices: memory 1012, one or more processors 1014, one or more presentation components 1016, one or more input/output (I/O) ports 1018, one or more I/O components 1020, and an illustrative power supply 1022. Bus 1010 represents what may be one or more busses (such as an address bus, data bus, or combination thereof). Although the various blocks of FIG. 10 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 10 is merely illustrative of an exemplary computing device that can be used in connection with one or more embodiments of the present disclosure. Distinction is not made between such categories as “workstation,” “server,” “laptop,” “handheld device,” etc., as all are contemplated within the scope of FIG. 10 and with reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 1012 includes computer storage media in the form of volatile and/or nonvolatile memory. The memory may be removable, non-removable, or a combination thereof. Exemplary hardware devices include solid-state memory, hard drives, optical-disc drives, etc. Computing device 1000 includes one or more processors 1014 that read data from various entities such as memory 1012 or I/O components 1020. Presentation component(s) 1016 presents data indications to a user or other device. Exemplary presentation components include a display device, speaker, printing component, vibrating component, and the like.

The I/O ports 1018 allow computing device 1000 to be logically coupled to other devices, including I/O components 1020, some of which may be built in. Illustrative components include a microphone, joystick, game pad, satellite dish, scanner, printer, wireless device, etc. The I/O components 1020 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 1000. The computing device 1000 may be equipped with depth cameras, such as stereoscopic camera systems, infrared camera systems, RGB camera systems, and combinations of these, for gesture detection and recognition. Additionally, the computing device 1000 may be equipped with accelerometers or gyroscopes that enable detection of motion. The output of the accelerometers or gyroscopes may be provided to the display of the computing device 1000 to render immersive augmented reality or virtual reality.

Some embodiments of computing device 1000 may include one or more radio(s) 1024 (or similar wireless communication components). The radio 1024 transmits and receives radio or wireless communications. The computing device 1000 may be a wireless terminal adapted to receive communications and media over various wireless networks. Computing device 1000 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present disclosure have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

1. A computer-implemented method for reconciling one or more data fields across disparate software platforms, comprising:
obtaining a candidate modification parameter indicating a candidate modification to apply to an event;
in response to obtaining the candidate modification parameter, determining a resource collection, from among a plurality of resource collections, to support the event, the resource collection determined based on the candidate modification parameter and a set of resource parameters associated with the resource collection;
identifying a modification to be applied to modify the event in accordance with the candidate modification parameter; and
initiating an event modification by instructing at least one resource management software to modify event data associated with the event so as to correspond to the event modification.

2. The computer-implemented method of claim 1, wherein the candidate modification parameter comprises a resource indicator that represents an amount of resources to be transferred or a scheduled time or time range for a resource transfer in association with the event.

3. The computer-implemented method of claim 1, wherein the candidate modification parameter is provided via a destination entity that is to receive a resource transfer in association with the event.

4. The computer-implemented method of claim 1, wherein each the plurality of resource collections correspond with a source entity that is provide a resource transfer in association with the event or a third-party entity that is willing to provide the resource transfer on behalf of the source entity.

5. The computer-implemented method of claim 1, wherein each of the plurality of resource collections have a corresponding set of resource parameters provided by a resource provider entity.

6. The computer-implemented method of claim 1, wherein determining the resource collection, from among the plurality of resource collections, comprises identifying that the candidate modification parameter aligns with set of resource parameters associated with the resource collection.

7. The computer-implemented method of claim 1, wherein initiating the event modification comprises instructing a first management software operated by a first entity and a second management software operated by a second entity.

8. A computing device, comprising:
one or more processors; and
computer storage memory having computer-executable instructions stored thereon which, when executed by the processor, implement a method comprising:
obtaining a set of candidate modification parameters indicating a set of candidate modifications to apply to an event, the set of candidate modification parameters including a resource amount modification rate;
in response to obtaining the candidate modification parameter, identifying a resource collection, from among a plurality of resource collections, to support the event, wherein the resource collection is identified by:
determining that the event qualifies for the resource collection based on a comparison of the set of candidate modification parameters and/or event data associated with the event attaining at least one resource parameter associated with the resource collection, and
determining that the event is authorized for support by the resource collection based on the resource amount modification rate associated with the event exceeding a target rate corresponding with the resource collection;
identifying a modification to be applied to modify the event in accordance with the set of candidate modification parameters; and
initiating an event modification by instructing at least one resource management software to modify event data associated with the event so as to correspond to the event modification.

9. The computing device of claim 8, wherein determining that the event qualifies for the resource collection is further based on analysis of the event data associated with the event.

10. The computing device of claim 8, wherein the at least one resource management software modifies the event data associated with the event.

11. The computing device of claim 8, wherein each the plurality of resource collections correspond with a source entity that is provide a resource transfer in association with the event or a third-party entity that is willing to provide the resource transfer on behalf of the source entity.

12. The computing device of claim 8, wherein each of the plurality of resource collections have a corresponding set of resource parameters provided by a resource provider entity.

13. The computing device of claim 12, wherein each of the corresponding set of resource parameters are different from one another.

14. The computing device of claim 8, wherein the at least one resource parameter associated with the resource collection comprises an entity attribute, a date range, or a resource amount.

15. Computer storage memory having computer-executable instructions stored thereon which, when executed by the processor, implement a method comprising:
obtaining a set of candidate modification parameters indicating a set of candidate modifications to apply to an event;
in response to obtaining the candidate modification parameter, identifying a first resource collection, from among a plurality of resource collections, to support the event based on the set of candidate modification parameters and a set of resource parameters associated with the resource collection, the plurality of resource collections includes the first resource collection associated with a third-party entity that is willing to provide a resource transfer associated with the event on behalf of a source entity and a second resource collection associated with the source entity that is initially to provide the resource transfer in association with the event;
identifying a modification to be applied to modify the event in accordance with the set of candidate modification parameters; and
initiating an event modification by instructing a resource management software associated with the third-party entity to perform a first modified resource transfer comprising a modified resource amount at a modified date to a destination entity and by instructing a resource management software associated with the source entity to perform a second modified resource transfer comprising an unmodified resource amount to the third-party entity.

16. The computer storage memory of claim 15, wherein determining the resource collection, from among the plurality of resource collections, comprises identifying that the set of candidate modification parameters aligns with set of resource parameters associated with the resource collection.

17. The computer storage memory of claim 15, wherein the plurality of resource collections comprises a stack of resource collections organized in a priority order such that a higher priority resource collection is analyzed before analyzing a lower priority resource collection.

18. The computer storage memory of claim 15, wherein the set of candidate modification parameters is provided via the destination entity that is to receive the modified resource amount.

19. The computer storage memory of claim 15, wherein the event modification is further initiated by instructing a resource management software associated with the destination entity to modify event data in association with the first modified resource amount at the modified date by the destination entity.

20. The computer storage memory of claim 15, wherein the modification to be applied comprises one of the candidate modification parameters.
